(19) United States
(12) Patent Application Publication
(10) Pub. No.: US 2010/0241466 A1
(43) Pub. Date: Sep. 23, 2010

(54) CASH BALANCE PENSION ADMINISTRATION SYSTEM AND METHOD

(75) Inventors: Fletcher K. Chambers, Powell, OH (US); Michael E. Nelson, Powell, OH (US); David Derek Wall, Columbus, OH (US)

Correspondence Address: Howard IP Law Group, P.O. Box 226, Fort Washington, PA, 19034, US

(73) Assignee: Hartford Fire Insurance Company, Hartford, CT (US)

(21) Appl. No.: 12/793,538

(22) Filed: Jun. 3, 2010

Related U.S. Application Data
(63) Continuation-in-part of application No. 12/505,165, filed on Jul. 17, 2009.
Application No. 12/505,165 is a continuation of application No. 10/152,516, filed on May 22, 2002, now Pat. No. 7,613,641.
(60) Provisional application No. 61/185,502, filed on Jun. 9, 2009.

(51) Int. Cl. G06Q 40/00; G06Q 20/00; G06Q 10/00; G06F 3/048

(52) U.S. Cl. 705/4; 705/30; 705/32; 705/36 R; 705/39; 705/322; 715/810

(57) ABSTRACT

A cash balance pension plan setup and administration system based on a server connected to a network and accessible by user devices via the network, includes: a plan set up module configured for set up of a cash balance pension plan from one of the devices via the network, the plan set up module having pre-defined plan provisions and being configured to cause the device to prompt a user to select among the pre-defined plan provisions and to receive the selections and to establish a new cash balance plan in accordance with the received selections. The system further has a calculation engine configured to use stored formulas and the received selections to perform calculations for implementation of the new cash balance pension plan and an administrator module for establishing and determining rights of one or more administrators accessing the system via the network.

### RELATED APPLICATIONS

This application claims the benefit under 35 U.S.C. 119(e) of U.S. Provisional Patent Application Ser. No. 61/185,502, filed Jun. 9, 2009, and is a continuation-in-part of copending U.S. patent application Ser. No. 12/505,165, filed Jul. 17, 2009, which is a continuation of U.S. patent application Ser. No. 10/152,516, filed May 22, 2002, now U.S. Pat. No. 7,613,641, which applications are incorporated herein by reference in their entireties for all purposes.

### TECHNICAL FIELD

The present invention is in the field of automated systems and methods for pension administration. More specifically, the present invention relates to a system and method for defined benefit pension plan administration that universally provides setup, management and administration of a defined benefit pension plan, such as a defined benefit cash balance plan from a single system.

### BACKGROUND OF THE INVENTION

Pensions have long been one of the primary employment benefits designed to retain employees and help them attain financial security through their retirement years. Under plans in the broad category of defined benefit plans, the employee has a contractual right, upon meeting certain conditions, to a stream of income after retirement. The amount of the payments in the stream of income is normally based on the length of the employees employment and the wages that the employee received during all or a portion of the period of employment. The money to support the pensions in a defined benefit plan is generally administered through a trust established by the employer for the benefit of the employees.

Defined contribution plans are an alternative category of retirement plan. In defined contribution plans, the amounts that the employee and the employer contribute to the plan determine the plan assets. Each employee generally has an individual account with a balance. The employee has discretion as to employee contributions to the account, and typically has the right to direct investments in the account within a limited number of choices. The employer may also contribute to the accounts of individual employees; for example, a defined contribution plan may provide that the employer will match employee contributions up to a certain amount or percentage of pay. The employee bears the entire investment risk. As the employer has no obligation to guarantee a stream of payments or a lump sum payment to an employee at a future date, calculations associated with administration of defined contribution plans are straightforward. Such calculations may involve, for example, calculations of growth of contributed assets based on assumptions as to growth of assets in various classes.

A cash balance pension plan is a defined benefit pension plan that has certain characteristics of a defined benefit pension plan, and certain characteristics of a defined contribution plan. In a cash balance plan, each employee has a hypothetical account balance, generally defined by a credit based on a percentage of the employees pay. The employee has no discretion in the amounts credited to the accounts. Interest is periodically credited to the account. At retirement or termination, the employee typically has a contractual right to payment of the balance of the hypothetical account as a lump sum, or a right to an annuity purchased using the value of the hypothetical account. While an employee has a hypothetical account balance, applicable rules permit the employer to fund the plan with less than the sum of the balances of the employee accounts, so long as other requirements are met. The employee thus has a contractual right to benefits but not ownership of the account balance. All of the investment risk is with the employer.

Pensions under cash balance plans are subject to extensive statutory and regulatory limitations and conditions. The Employee Retirement Income Security Act (ERISA) is highly complicated and provides detailed regulations for many aspects of cash balance plans. In certain circumstances, ERISA may require that employers provide both the Labor Department and their employees with detailed descriptions of the benefits they are to receive. It also outlines which employees must receive a pension if one is offered, and it requires that a percentage of the retirement benefits become vested in the employees after they have worked for a given number of years and/or have reached a given age. ERISA also requires that pension plans provide benefits to an employees survivors upon his death. Companies that offer pension plans must be prepared to provide this information to their employees (Plan Participants) who retire, leave the company, become disabled, or die. The information must also be available to participants that remain employed.

Employers must adequately fund the program and adhere to fiduciary responsibilities established by the act. ERISA has established the Pension Benefit Guaranty Corporation (PBGC) to insure defined benefit plans. Employers must pay premiums so that their plans are covered by the PBGC. The termination of plans is also extensively regulated.

Benefits under applicable statutes and regulations are available to employers that establish pension plans that follow Congressionally established guidelines such as ERISA. Numerous statutory and regulatory qualifications are imposed on pension plans in order for benefits to be available. For example, pension plans must be vested and must meet minimum coverage requirements. Adherence to these statutory and regulatory requirements further complicates the administration process.

There are nearly 38,000 private defined benefit pension plans that are expected to provide retirement incomes for more than 43 million American workers. Administration of these pension plans is complex, cumbersome, and often expensive. They require oversight by certified actuaries. Pension plan administration and reporting processes vary widely across organizations and cost some organizations as much as $1,500 per employee per year. The high cost of pension plan administration and reporting is attributable in part to the continuously evolving regulatory framework that administrators are required to follow. The federal statutes, rules, and regulations that apply to the plans are enforced by the IRS and other agencies. Defined benefit pension plans must comply with definition requirements as well as reporting requirements established by the IRS, Department of Labor, and the PBGC. Each year, companies with defined benefit pension plans are required to produce a valuation report that is reviewed by an actuary who certifies that the plan is adequately funded. Valuation reports may be 50-60 pages or more in length and contain the results of an immense number of calculations. Employer data, relevant IRS code sections, and actuarial assumptions and methods are used to determine pension contribution requirements and financial reporting information. This information may have a significant impact on a companys fiscal planning.

Pension mathematics that are required to determine whether a plan is adequately funded are extremely complex. Ten of thousands of discrete formulas may be needed to complete the necessary calculations for a plan. In addition, there is a tremendous amount of interdependency between the formulas. Attempts to hardcode the mathematics into computer systems often fail due to high error rates in translating the formulas into source code.

Compliance with current laws is critical to the success of defined benefit pension plans. Pension plans that fail to meet the requirements imposed by the IRS, Department of Labor, and PBGC may be disqualified. Liability for non-compliance can be high. The plan administrator may be required to take corrective actions to bring the plan into compliance. In addition, the administrator of the non-compliant plan may be sued by employees or clients for failure to administer a compliant plan and may be required to pay monetary damages.

Pension plan administrators need to be able to monitor for ongoing compliance with the complex regulatory framework that has been established by the IRS, Department of Labor, and PBGC. Pension plan administrators also have a need for tools that address complex plan scenarios and frequent regulatory changes. Known solutions are customized for a particular pension plan. Known solutions do not incorporate the universe of highly complex pension plan provisions and actuarial logic into a single system. Individual actuaries are known to develop custom information technology solutions for pension plan administration that employ a variety of separate commercially available software packages to perform various tasks of pension plan administration. These custom information technology solutions may have limited flexibility and may require significant time of actuaries and information technology professionals in set up and administration of plans and in maintenance of the solutions.

Known solutions do not permit independent actuaries to set up and administer highly complex pension plans through an intuitive online system.

### SUMMARY OF THE INVENTION

A computer system and method are provided for creation and administration of cash balance pension plans. The computer system is remotely accessible and permits a user to design and administer a cash balance defined benefit pension plan. The system may include one or more templates in which certain provisions of a cash balance pension plans are predetermined, and certain provisions may be selected by a user. The system may permit authorized users to select one of the templates, and select one or more of the provisions available for selection. Upon receipt of the user selection of variables, the system performs the calculations needed for implementation of the cash balance pension plan. Variables available for selection may include formulas for determination of contributions and formulas for crediting of interest to participant accounts. The system may permit real time access by individual participants in the cash balance pension plans, and may permit access by individual participants to their individual account information. The system may be configured to perform calculations, responsive to requests by authorized actuaries or by individual participants, to forecast pension plan account balances at termination or retirement under various assumptions, and to display the forecast balances.

### DETAILED DESCRIPTION OF THE DRAWINGS

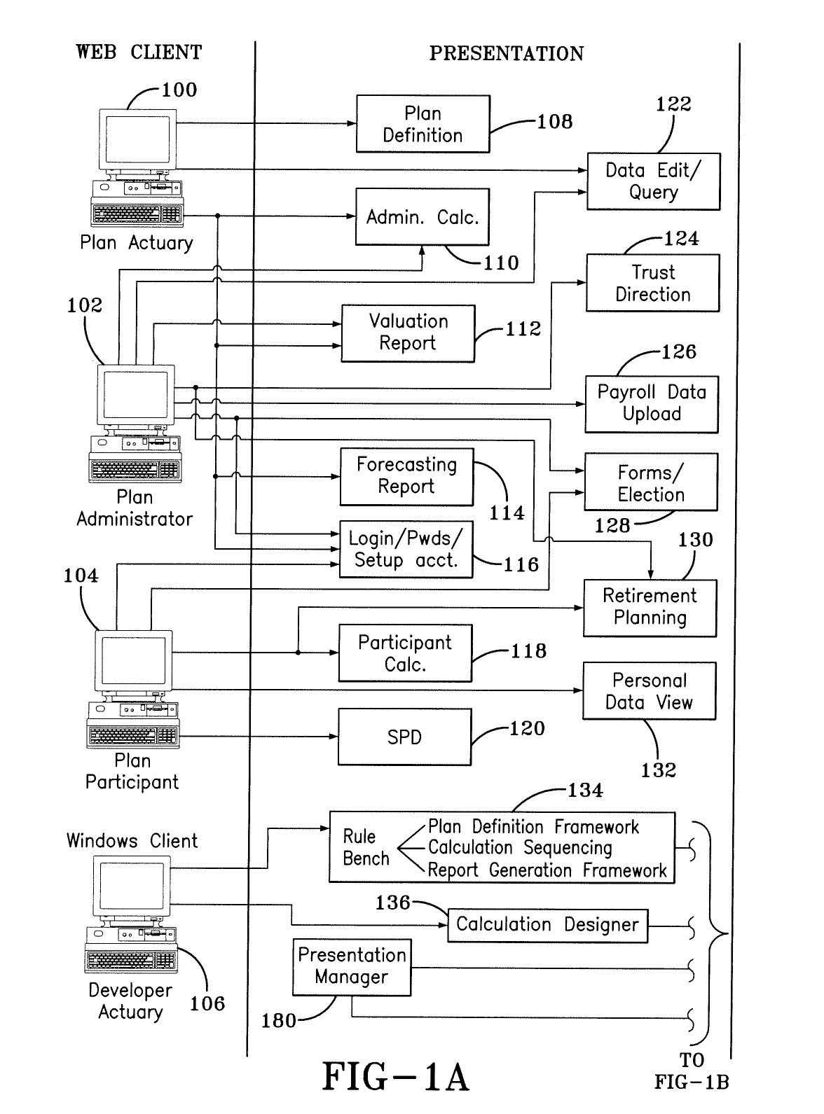

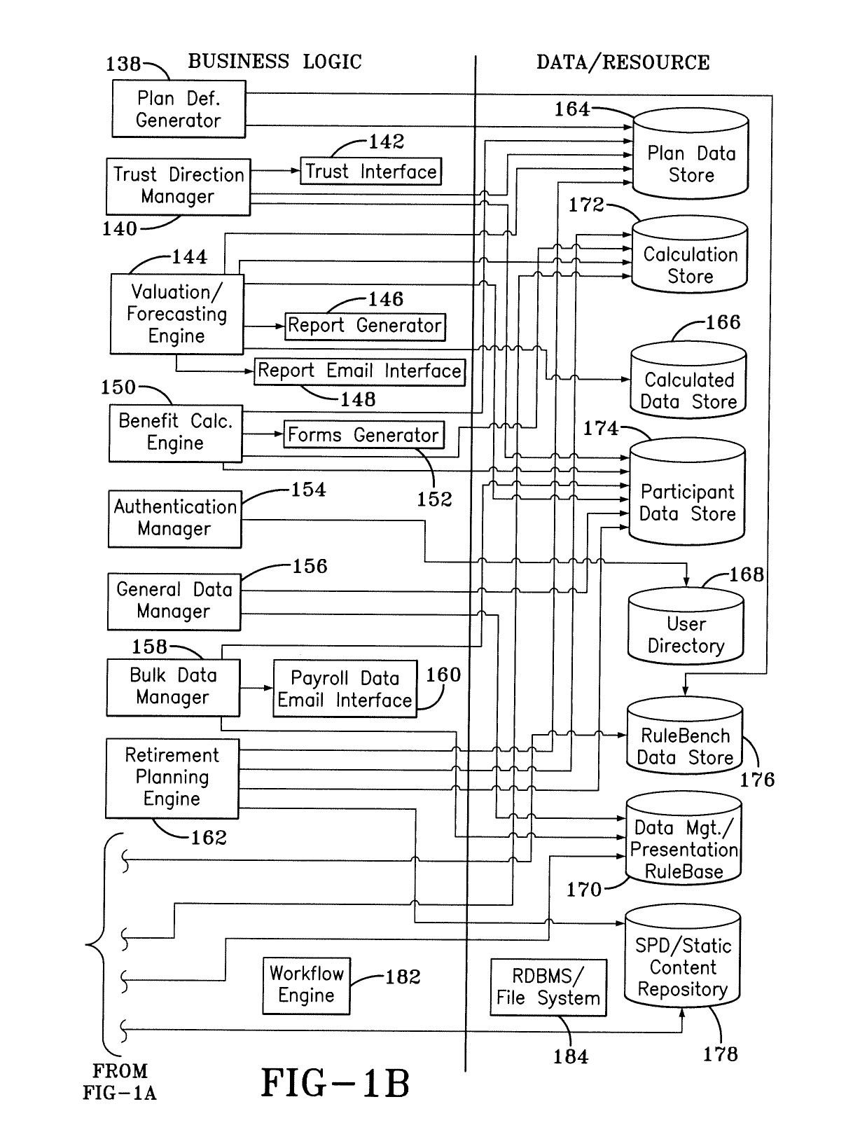

FIG. 1 is a block diagram of the primary components for an example embodiment of the present invention;

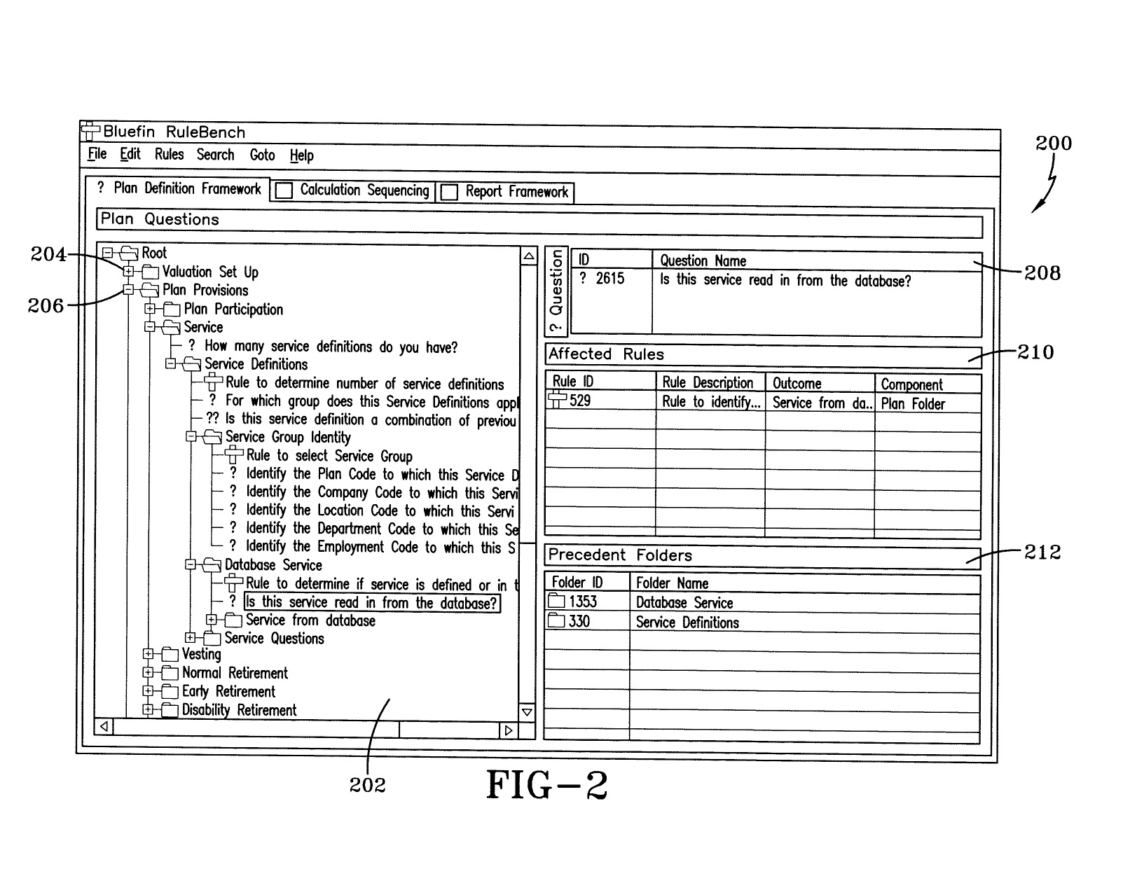

FIG. 2 is a plan definition framework tab of a RuleBench screen for a RuleBench component in accordance with an example embodiment of the present invention;

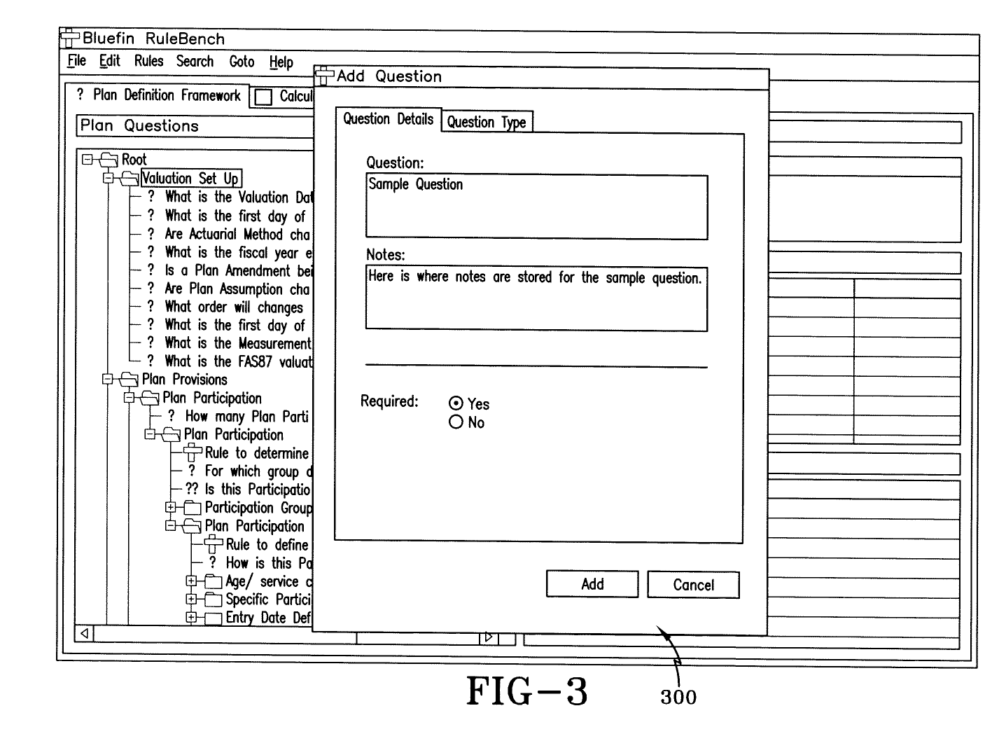

FIG. 3 is an add question screen of a RuleBench screen for a RuleBench component in accordance with an example embodiment of the present invention;

FIG. 4 is an add new plan rule screen of a RuleBench screen for a RuleBench component in accordance with an example embodiment of the present invention;

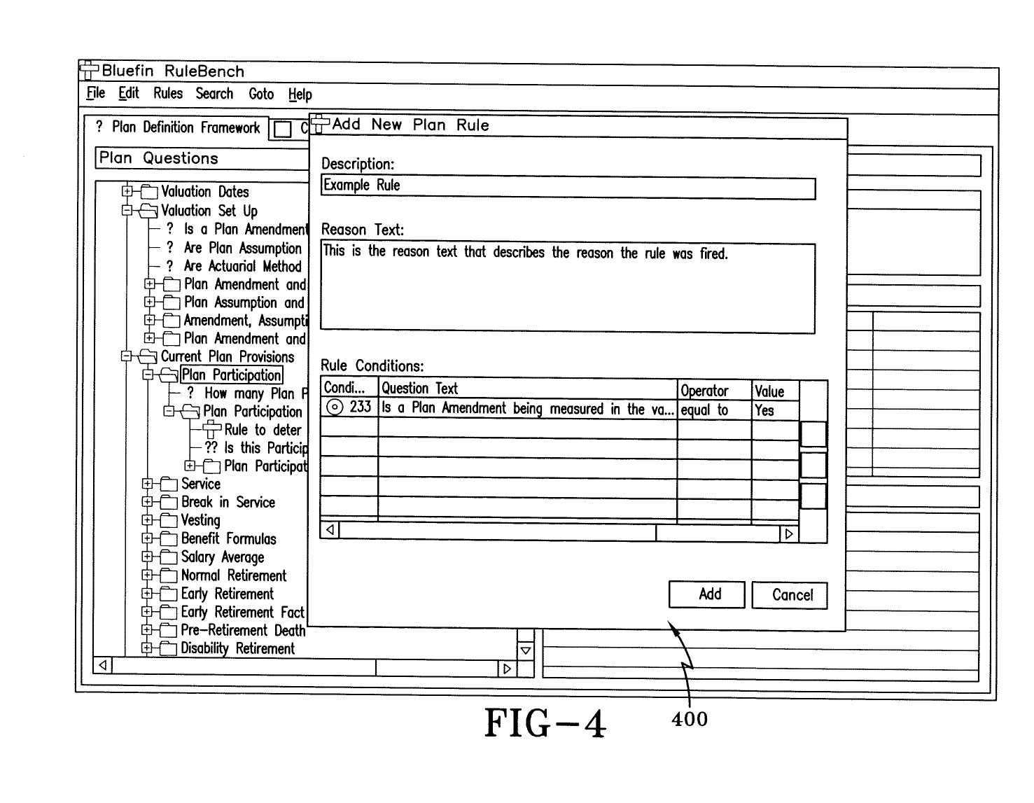

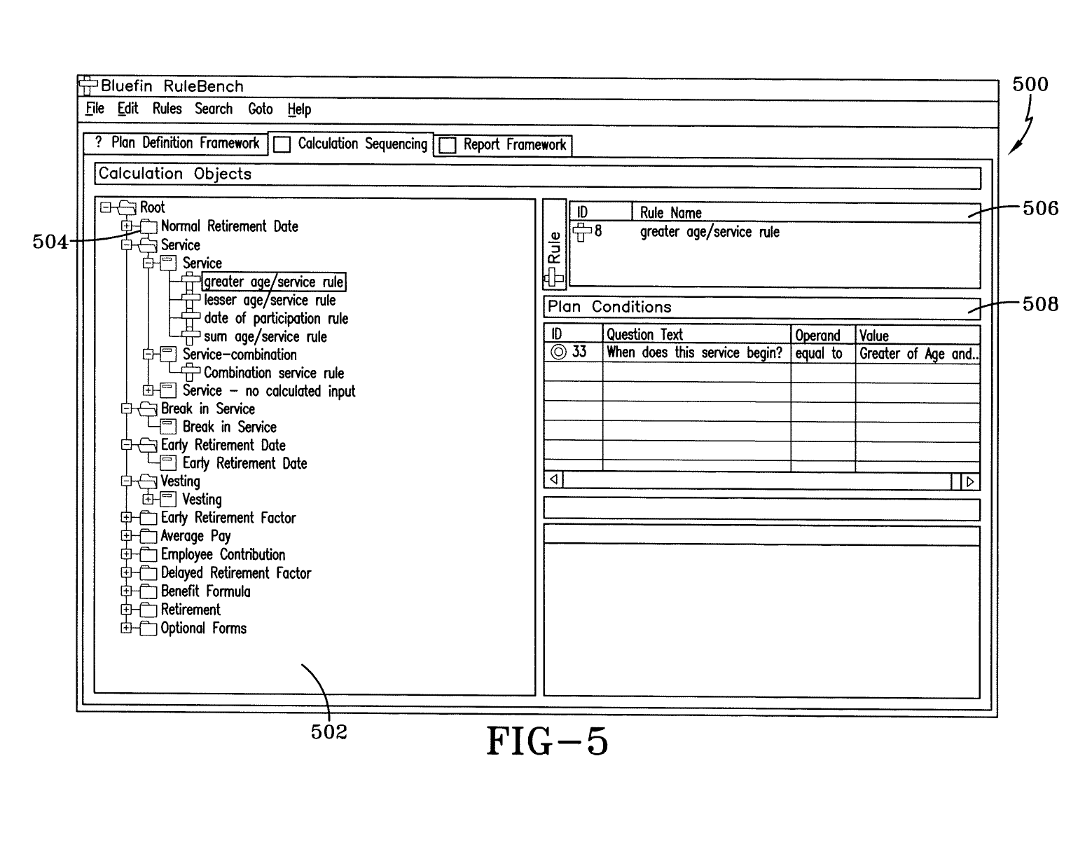

FIG. 5 is a calculation-sequencing tab of a RuleBench screen for a RuleBench component in accordance with an example embodiment of the present invention;

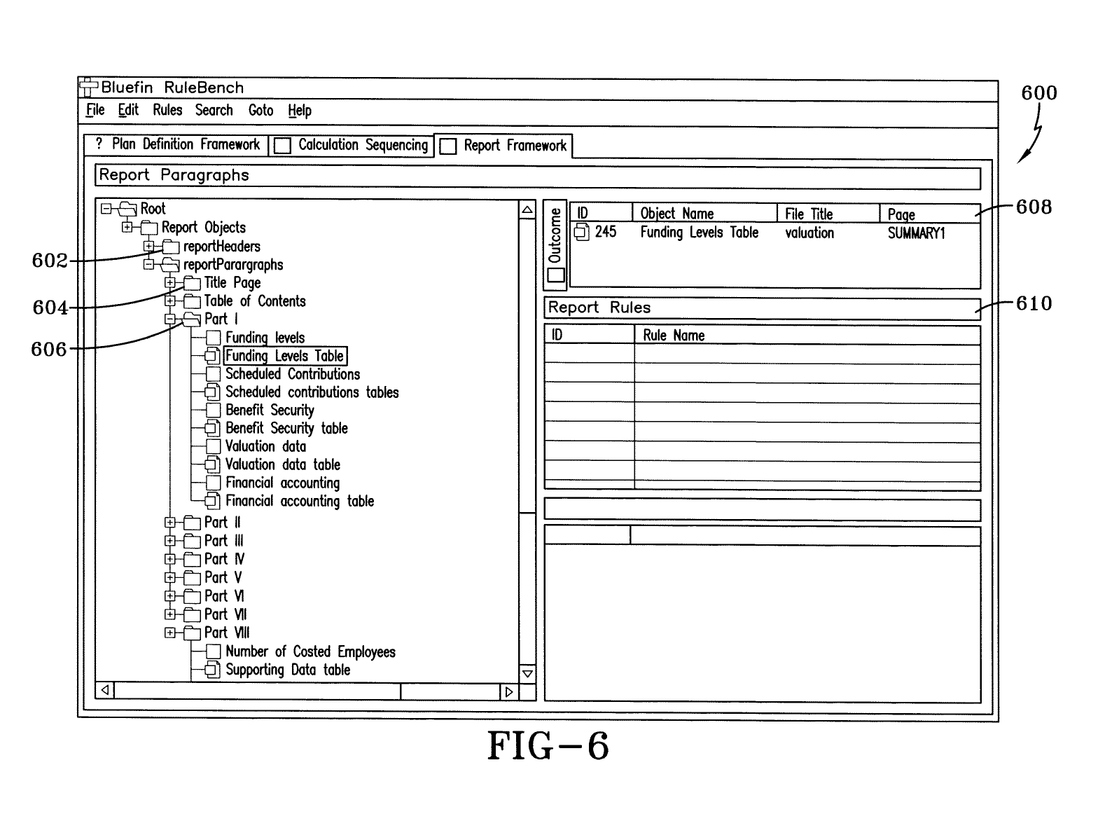

FIG. 6 is a report framework tab of a RuleBench screen for a RuleBench component in accordance with an example embodiment of the present invention;

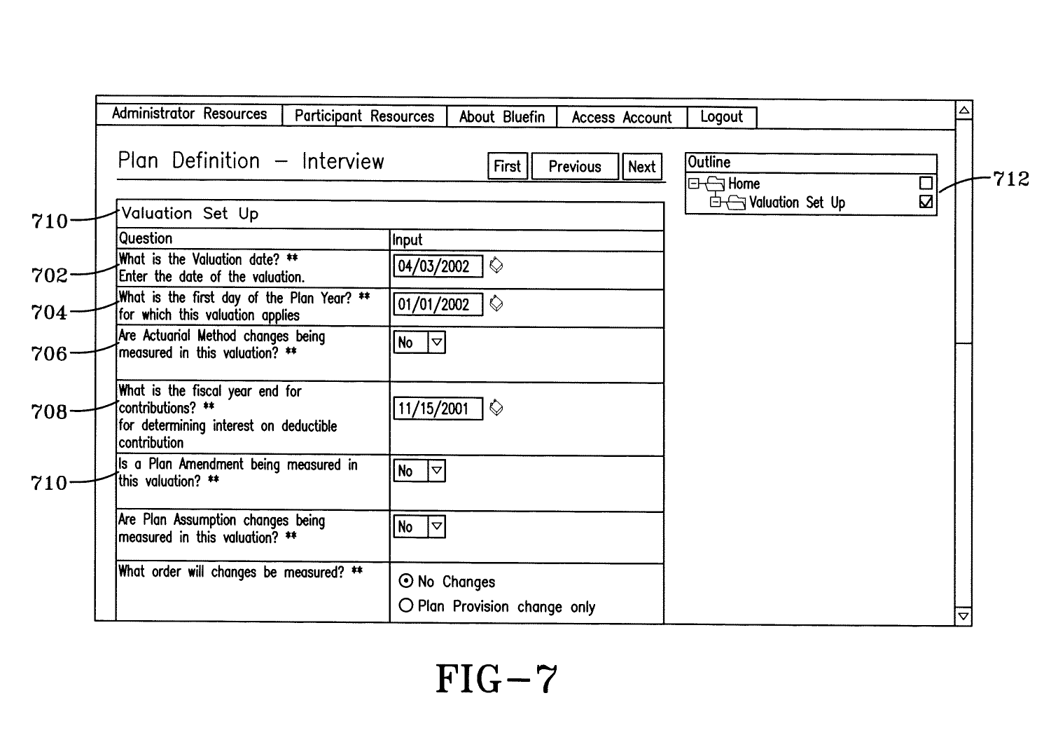

FIG. 7 is a plan definition screen for an example embodiment of a plan definition component in accordance with an example embodiment of the present invention;

FIG. 8 is a benefit summary” retirement screen for an example embodiment of the present invention; and

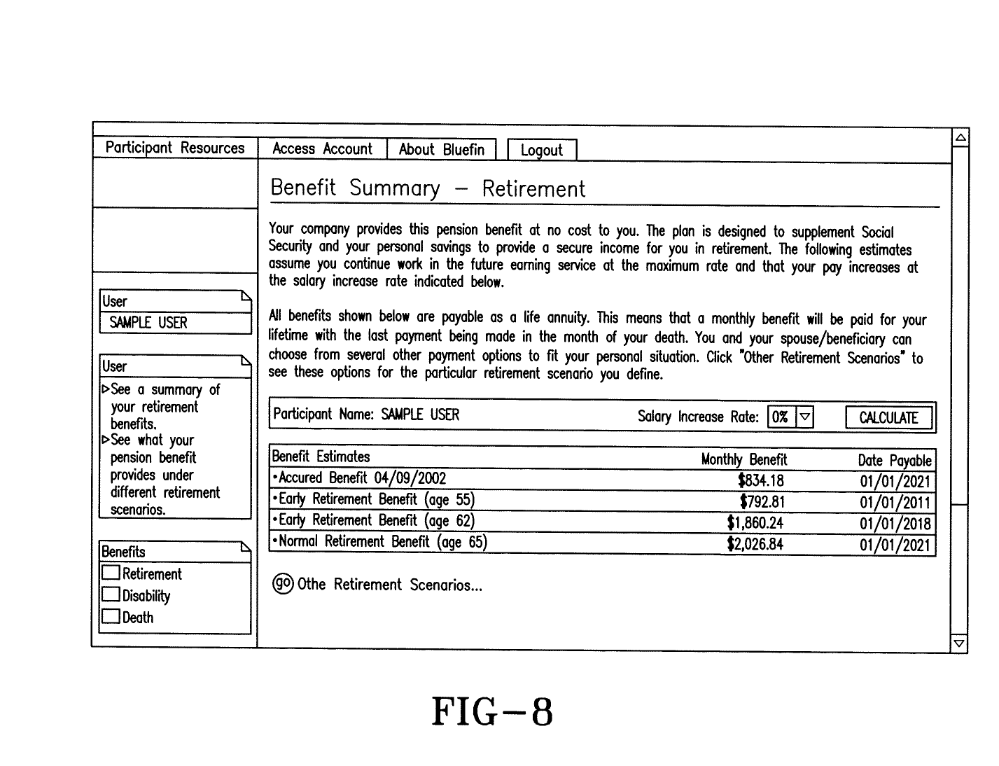

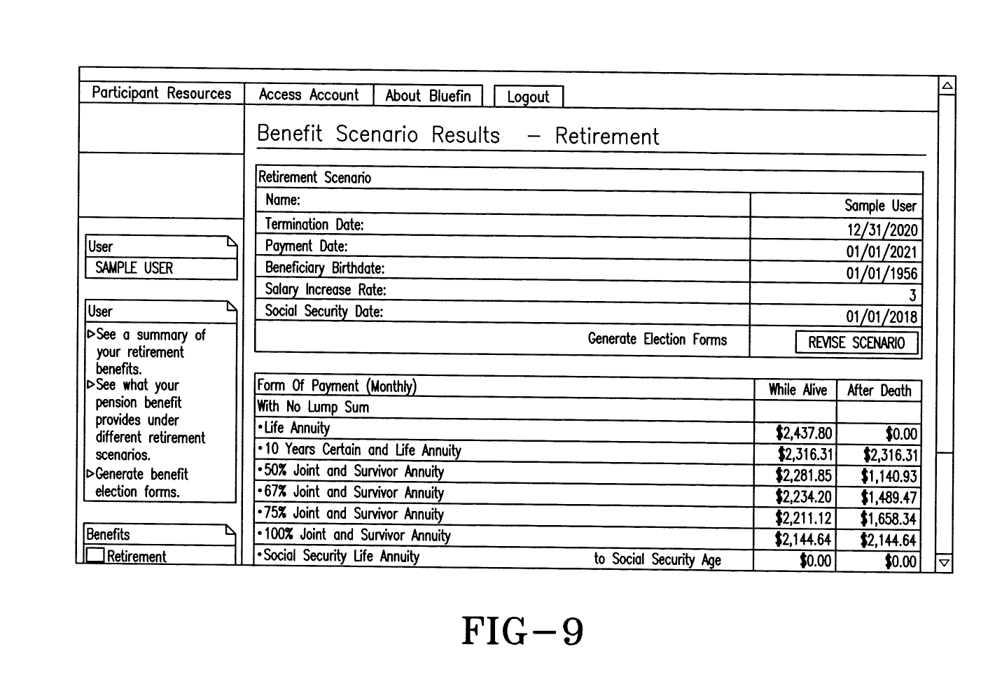

FIG. 9 is a benefit scenario results screen for an example embodiment of the present invention.

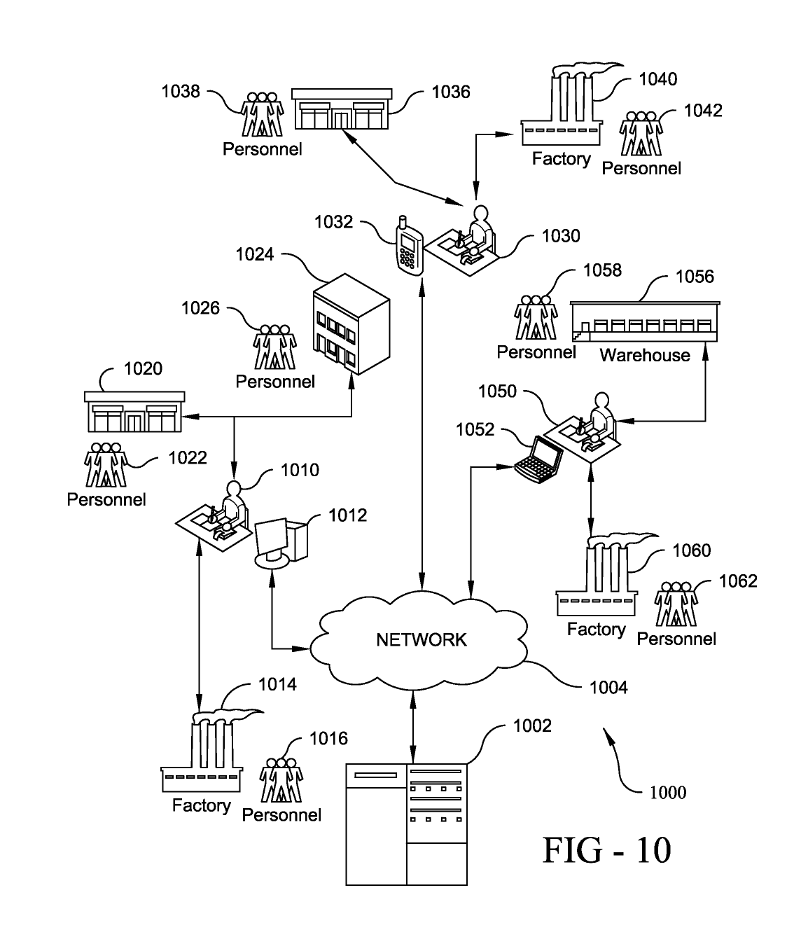

FIG. 10 is an exemplary arrangement in which a method and system according to an embodiment may be implemented.

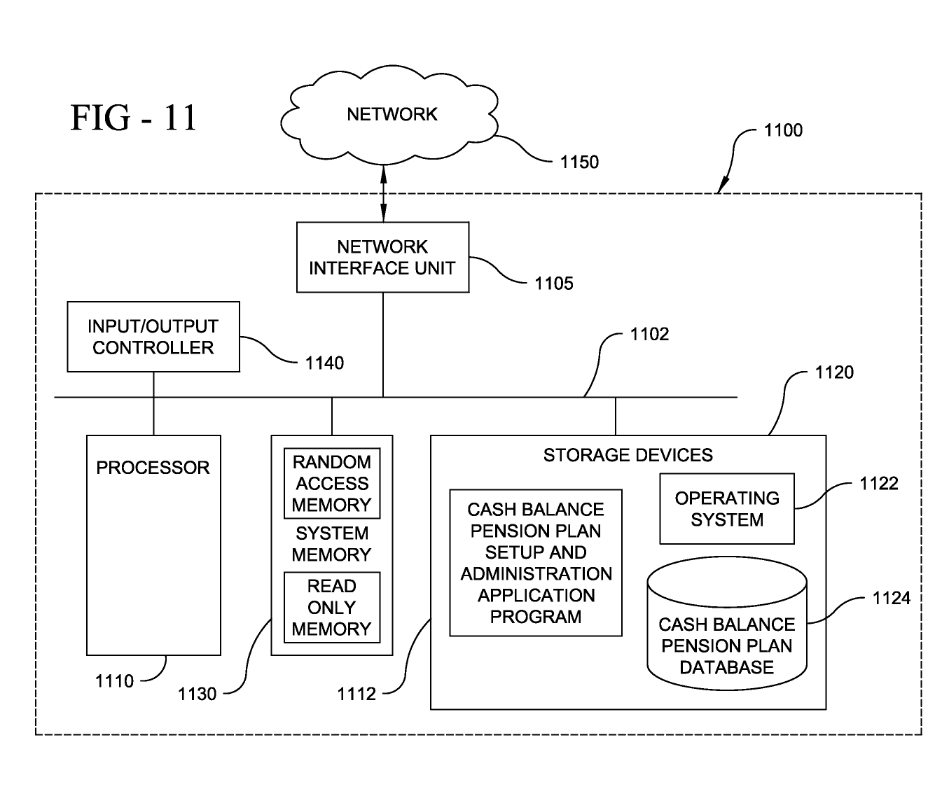

FIG. 11 is a schematic diagram of an exemplary computer system for implementation of a method and system of the invention.

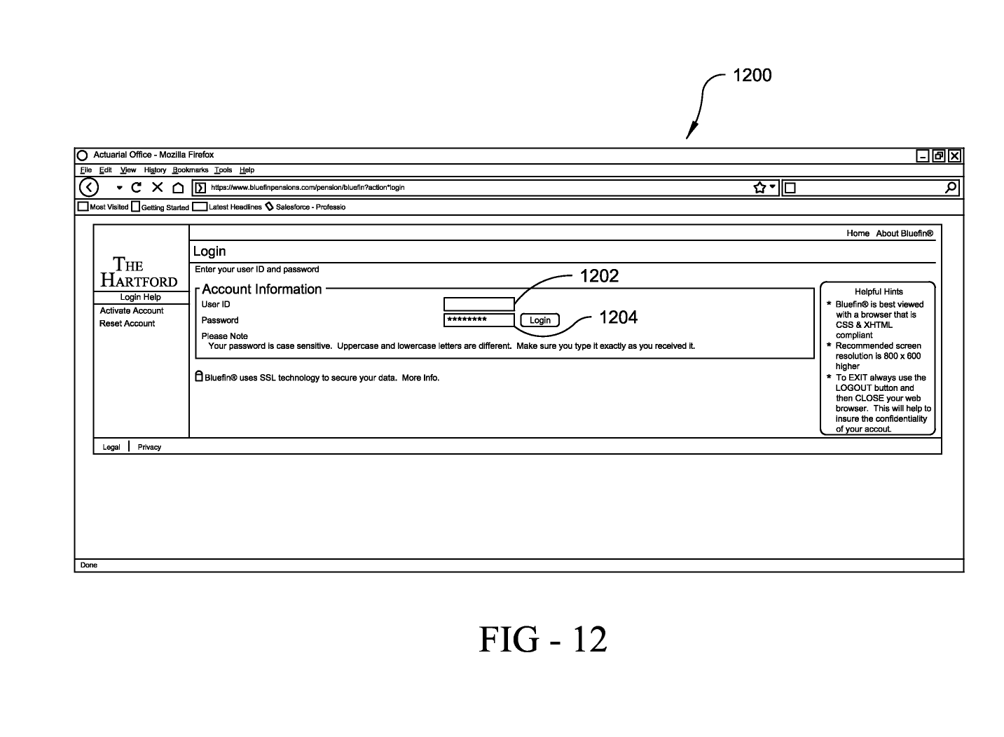

FIG. 12 is an exemplary authentication screen for an example embodiment of the present invention.

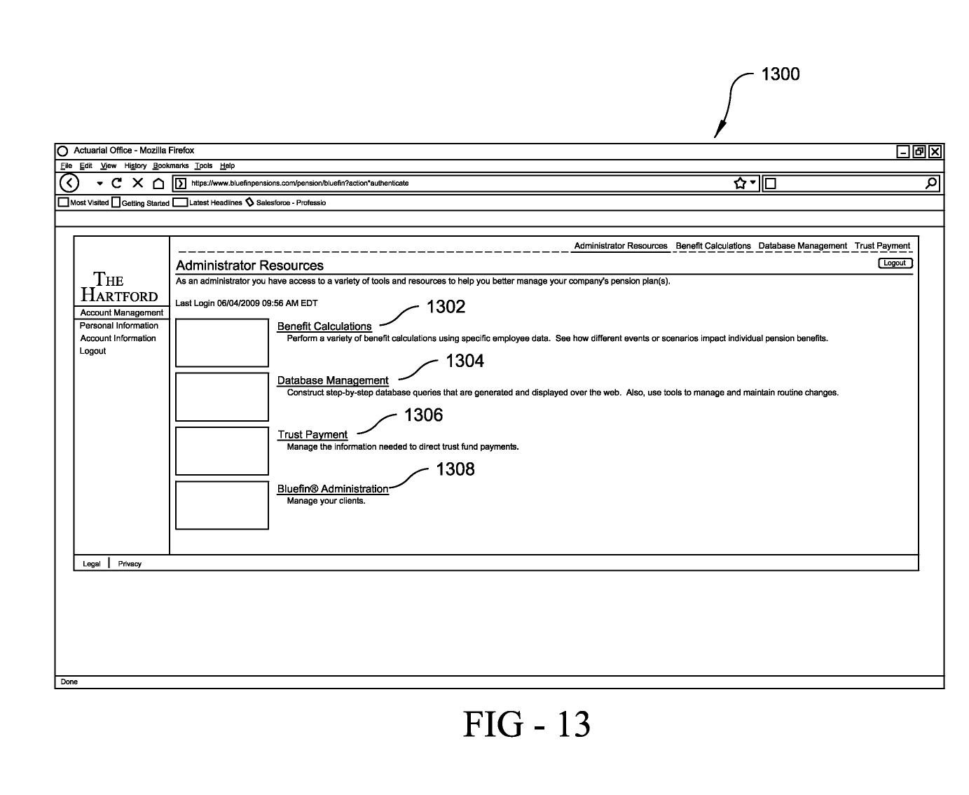

FIG. 13 is an exemplary screen showing an administrator home page in an example embodiment of the present invention.

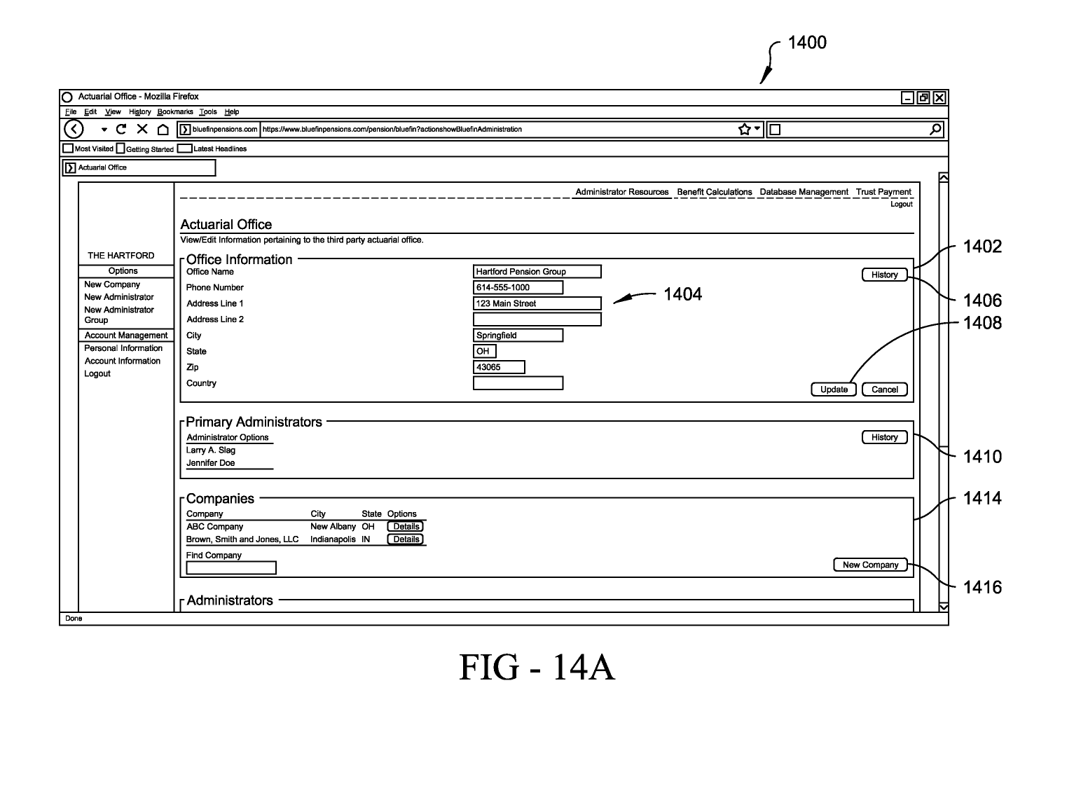

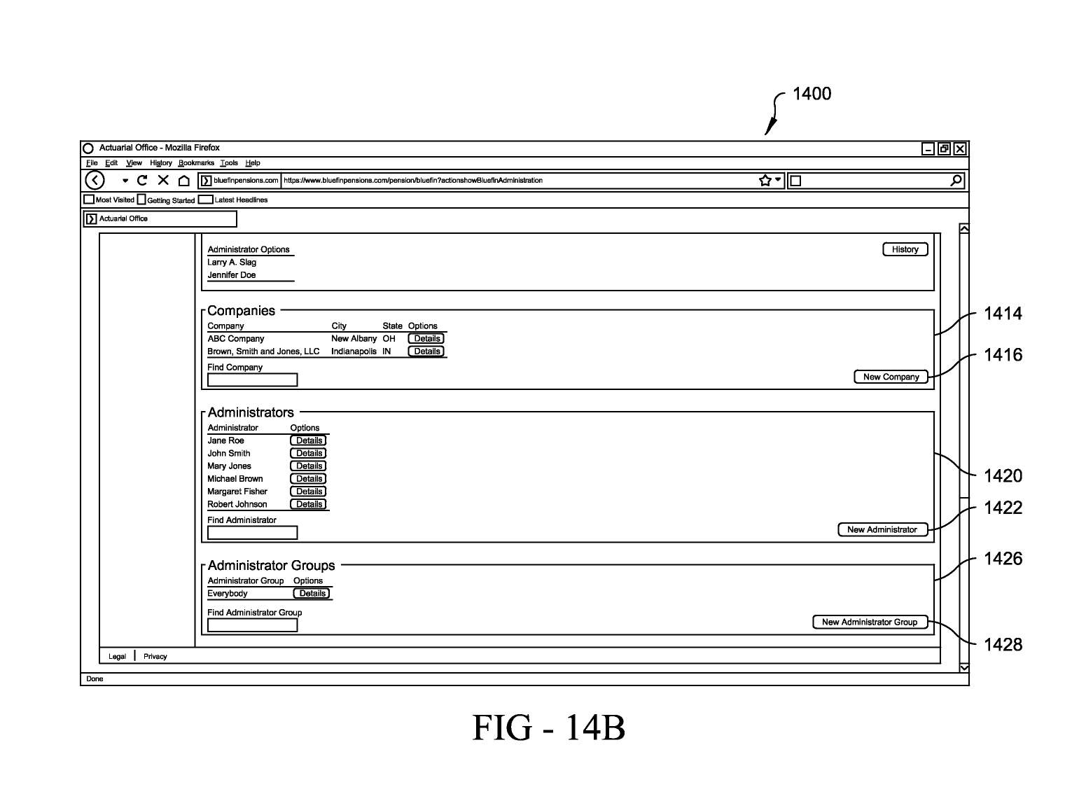

FIGS. 14A and 14B show an exemplary screen for managing data associated with an actuarial office in an example embodiment of the present invention.

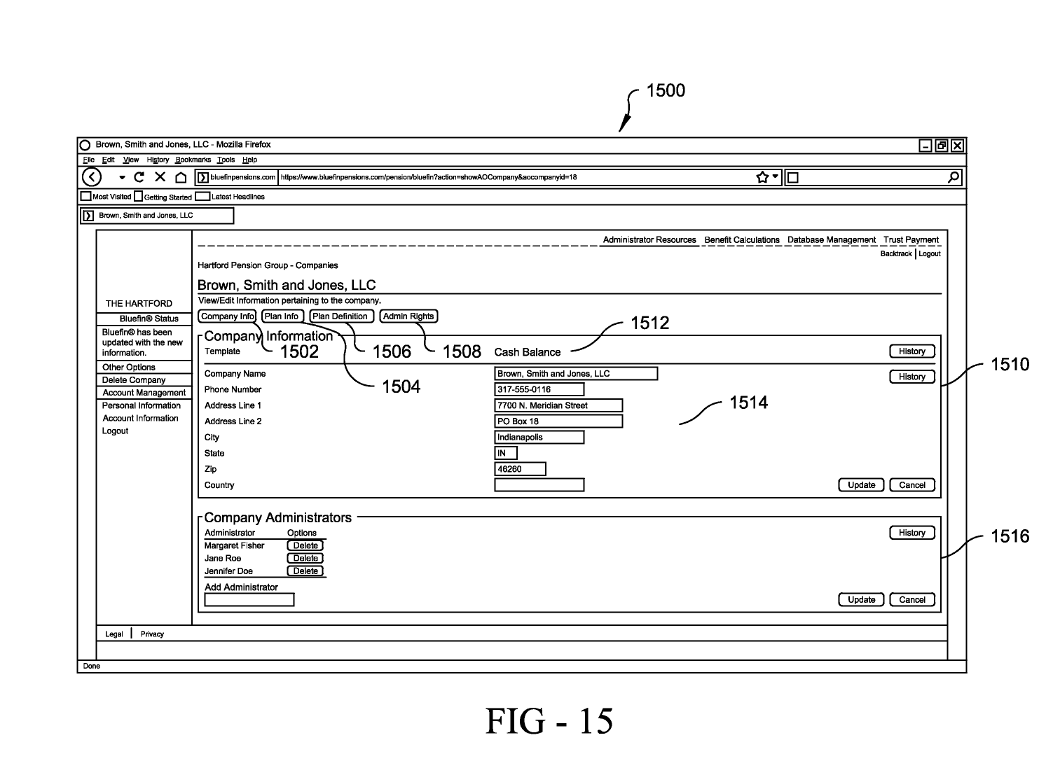

FIG. 15 is an exemplary screen showing a template selection for an example embodiment of the present invention.

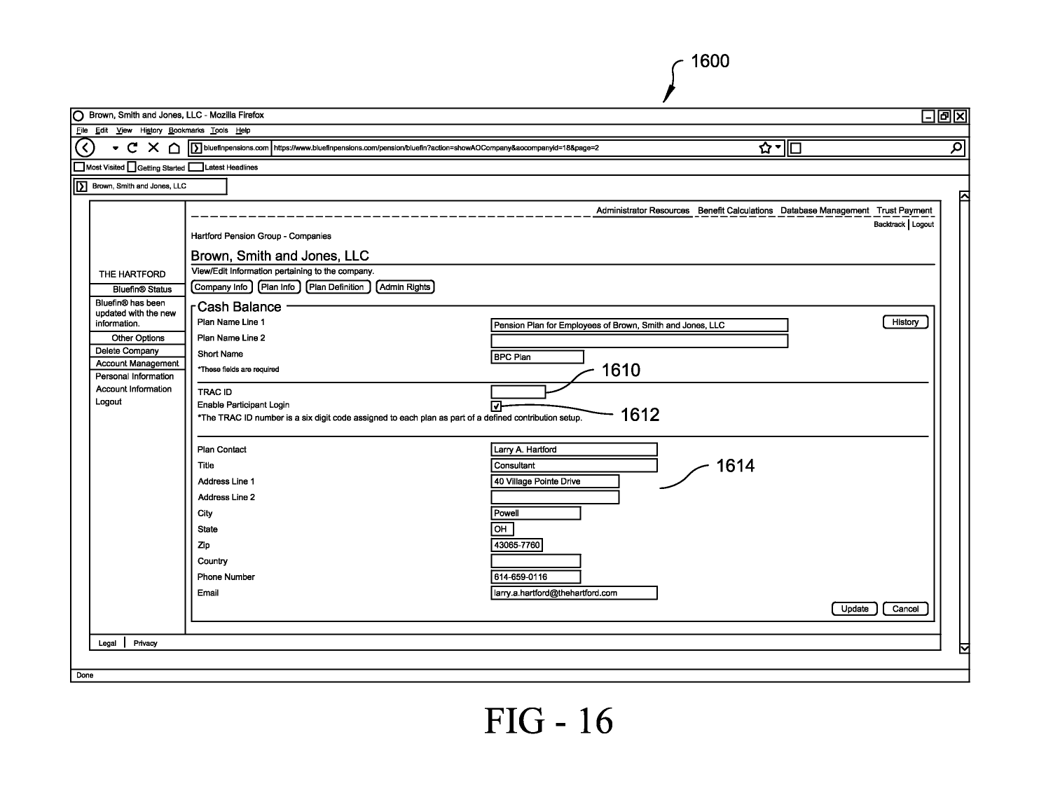

FIG. 16 is an exemplary screen illustrating plan identification code input for an example embodiment of the present invention.

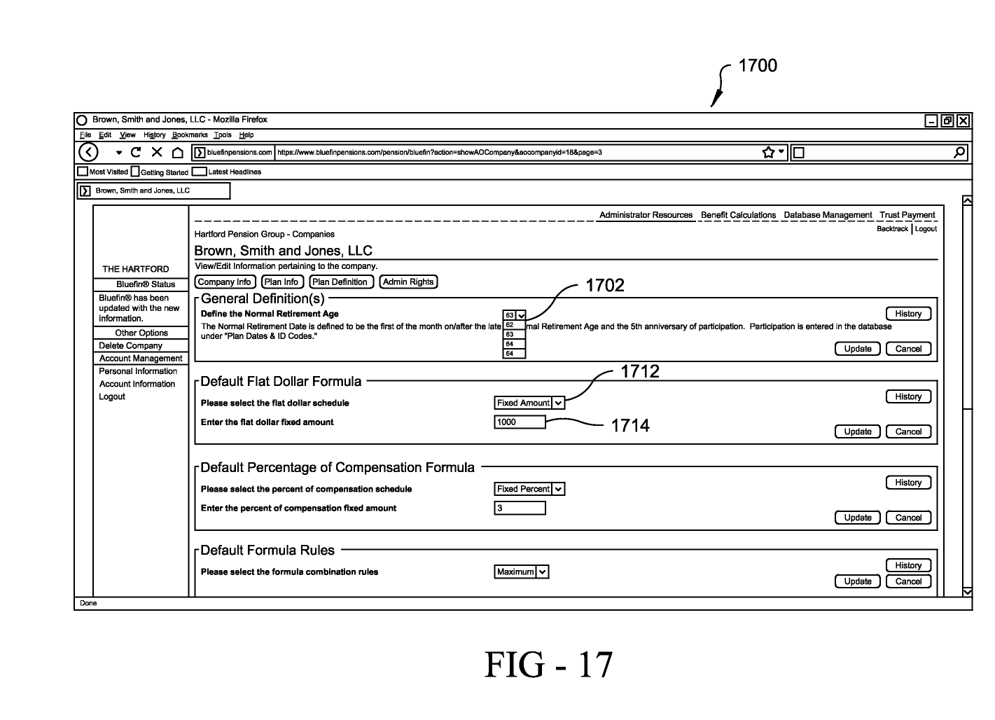

FIG. 17 is an exemplary screen illustrating selection of normal retirement age for an example embodiment of the present invention.

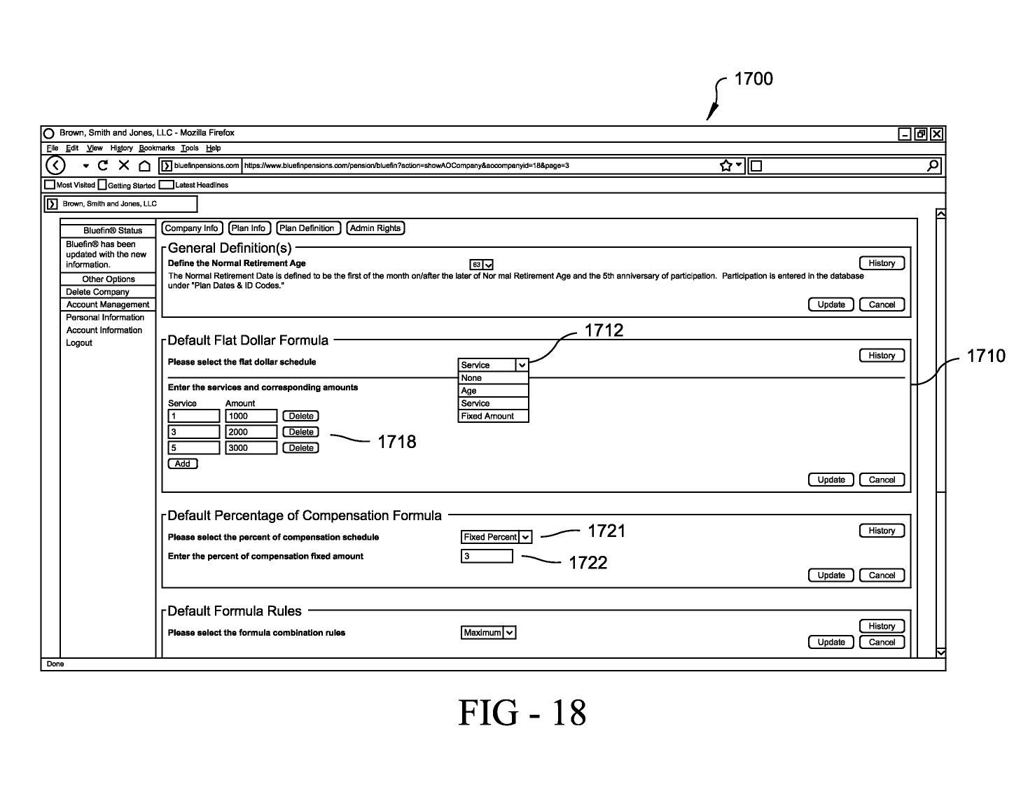

FIG. 18 is an exemplary screen illustrating selecting a service-based contribution flat dollar formula for an example embodiment of the present invention.

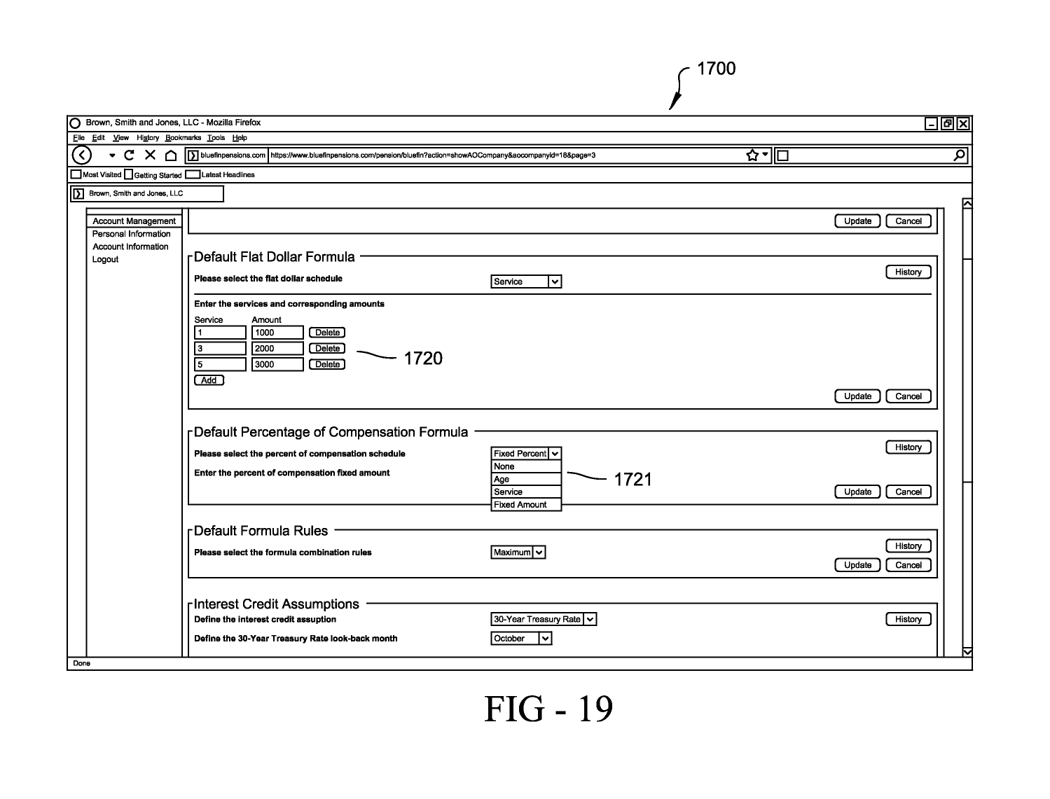

FIG. 19 is an exemplary screen illustrating selecting a percentage of compensation contribution formula for an example embodiment of the present invention.

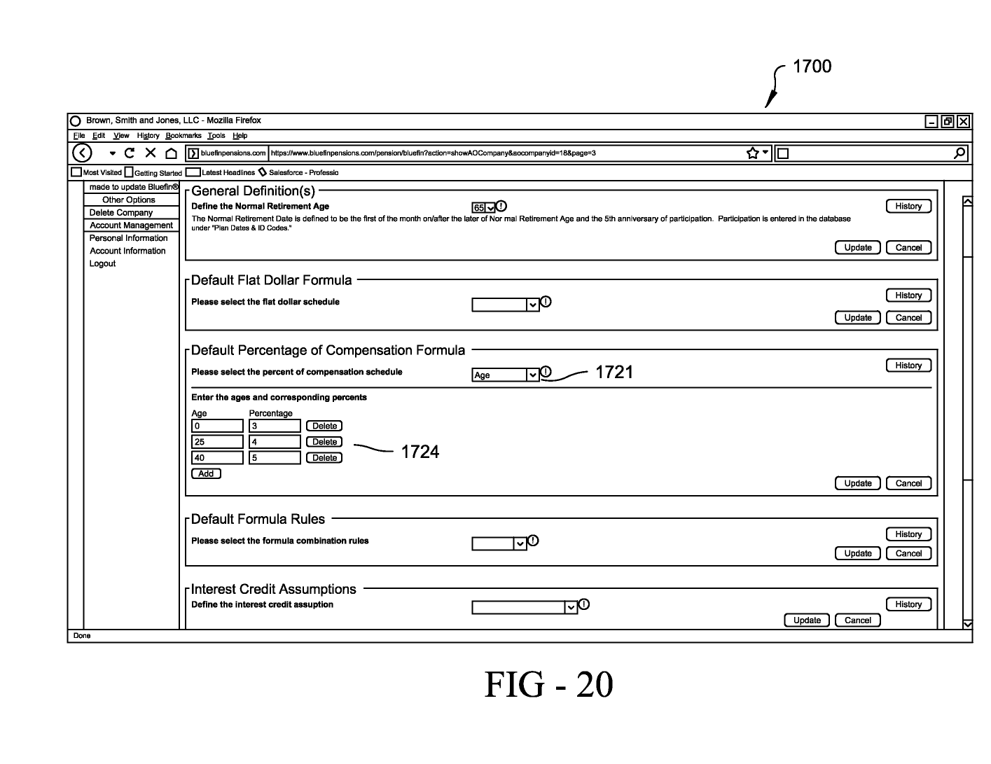

FIG. 20 is an exemplary screen illustrating selecting an age-based percentage of compensation contribution formula for an example embodiment of the present invention.

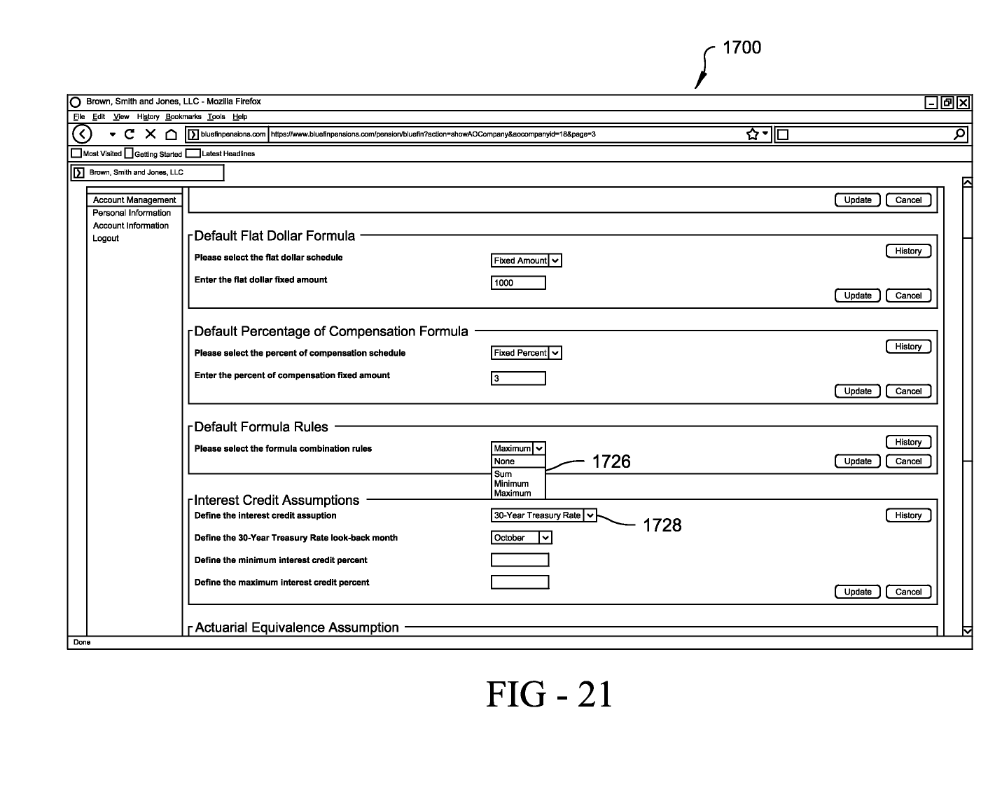

FIG. 21 is an exemplary screen illustrating selecting rules for reconciling contribution formulas for an example embodiment of the present invention.

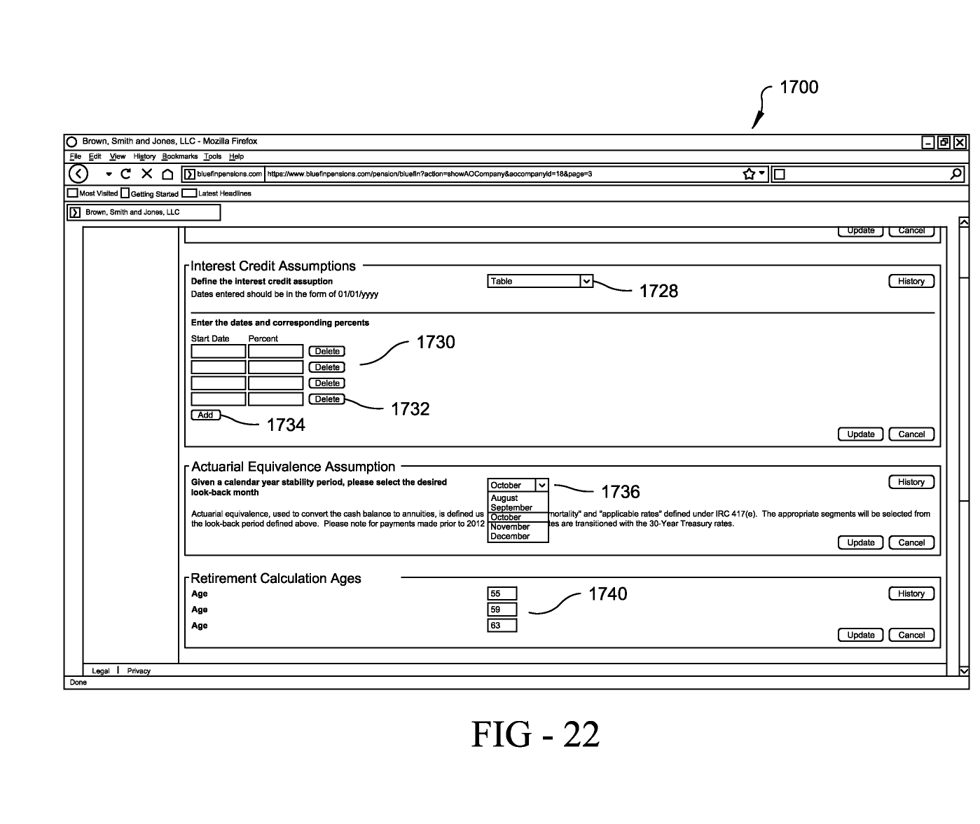

FIG. 22 is an exemplary screen illustrating selecting actuarial equivalence assumptions for an example embodiment of the present invention.

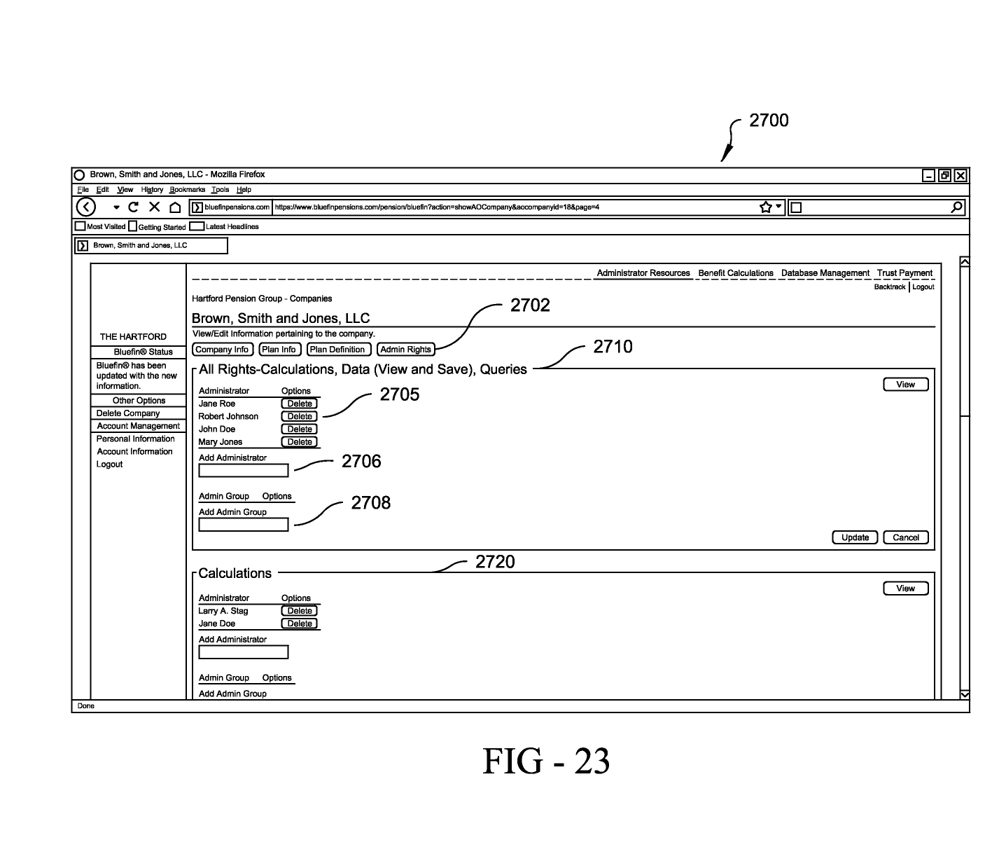

FIG. 23 is an exemplary screen illustrating selecting administrator rights for an example embodiment of the present invention.

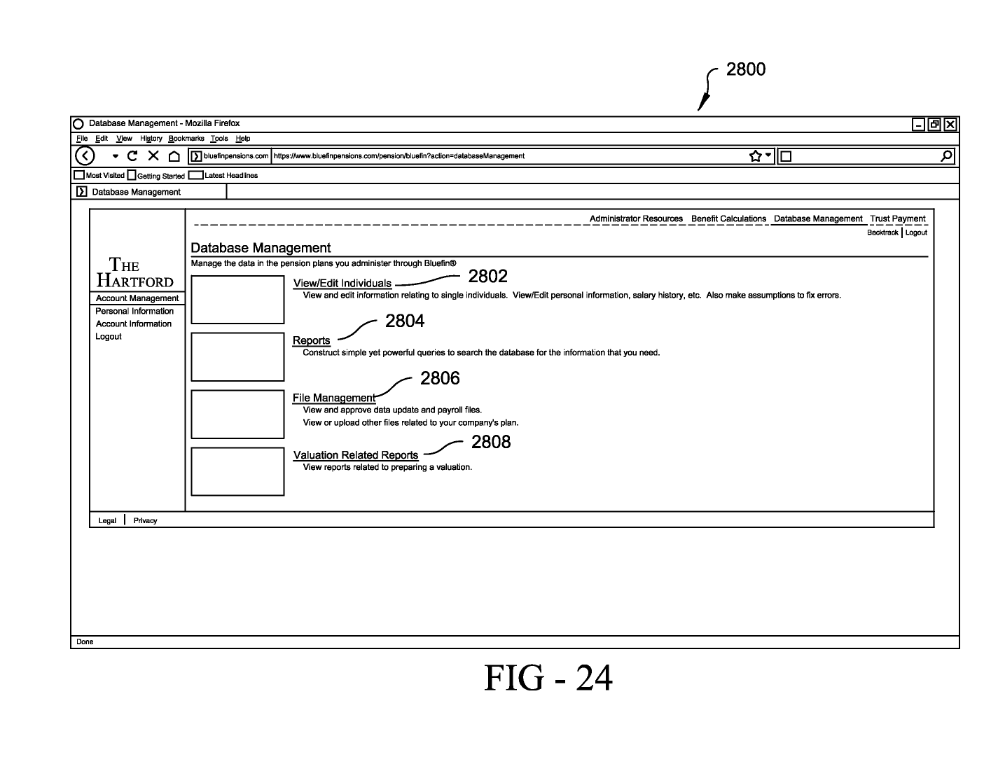

FIG. 24 is an exemplary screen illustrating database management options for an administrator for an example embodiment of the present invention.

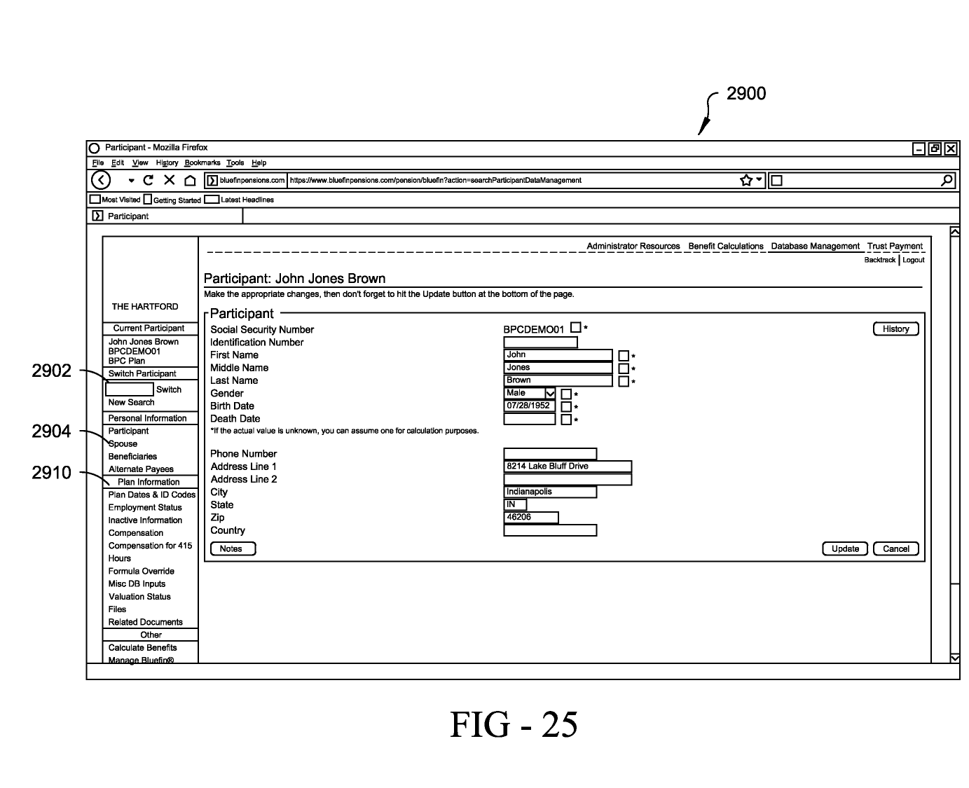

FIG. 25 is an exemplary screen illustrating participant data for an example embodiment of the present invention.

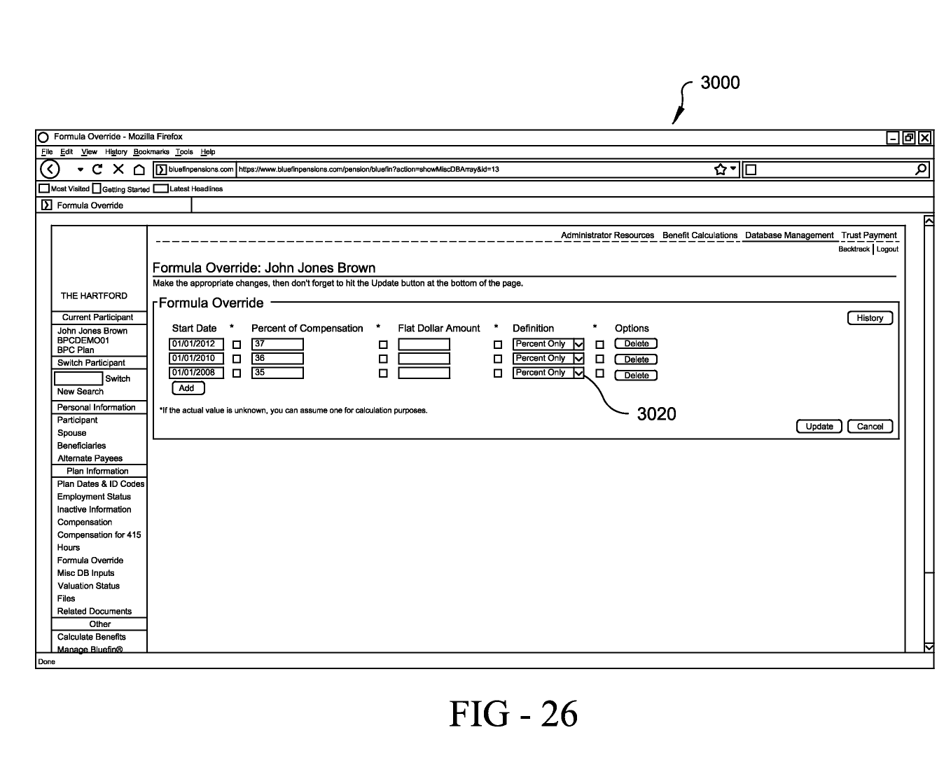

FIG. 26 is an exemplary screen illustrating selecting distinct contribution formula selection for an individual participant for an example embodiment of the present invention.

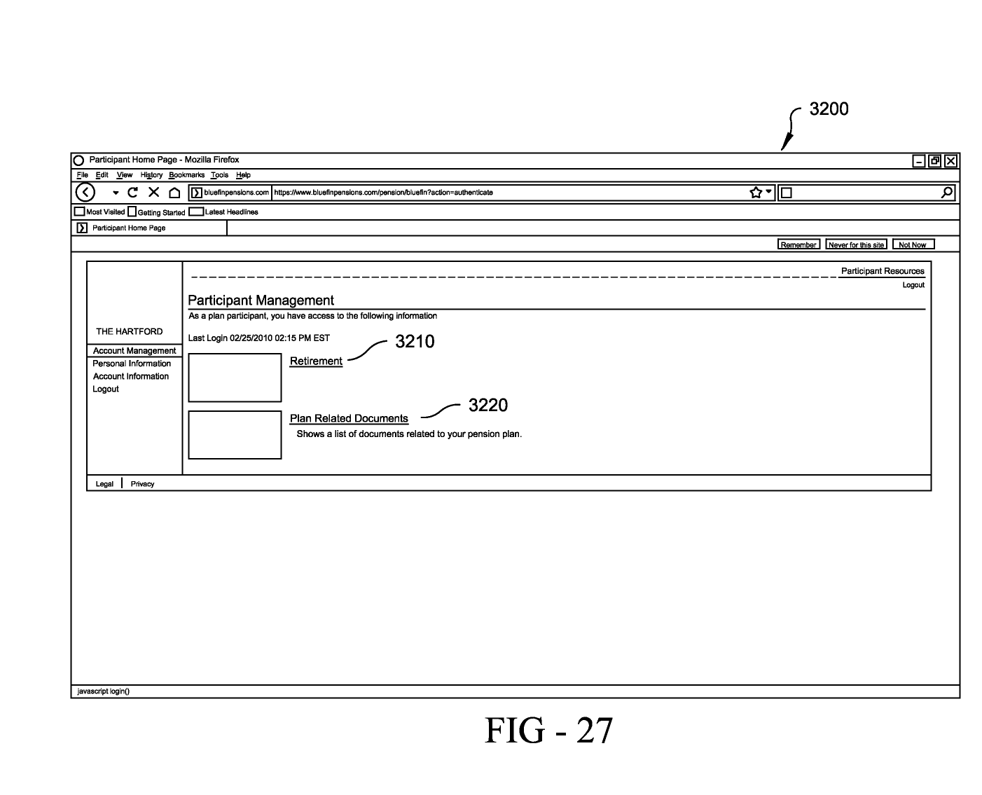

FIG. 27 is an exemplary screen illustrating resources available to a participant for an example embodiment of the present invention.

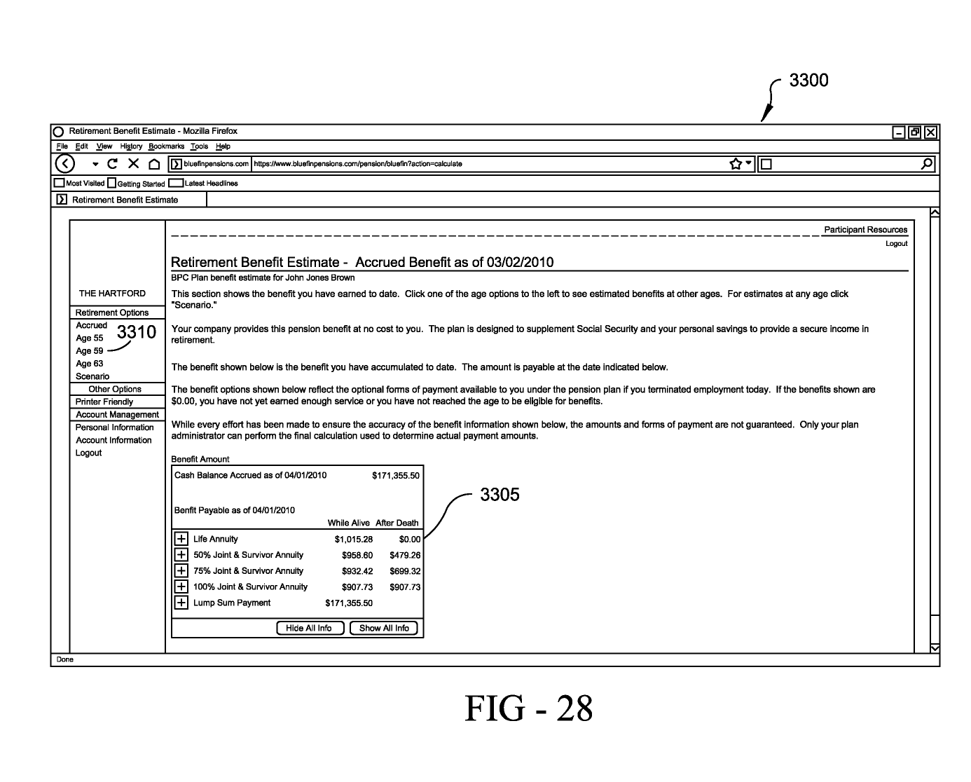

FIG. 28 is an exemplary screen illustrating retirement benefit estimates available to a participant for an example embodiment of the present invention.

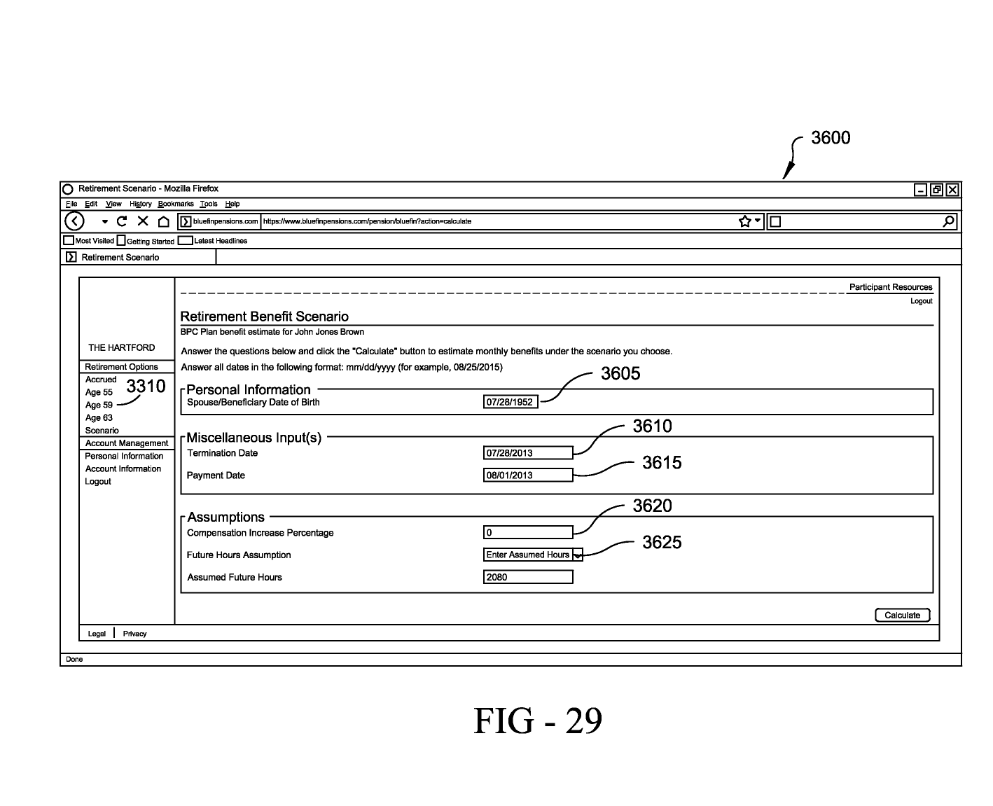

FIG. 29 is an exemplary screen illustrating variables available for selection by a participant in generating a retirement benefit scenario for an example embodiment of the present invention.

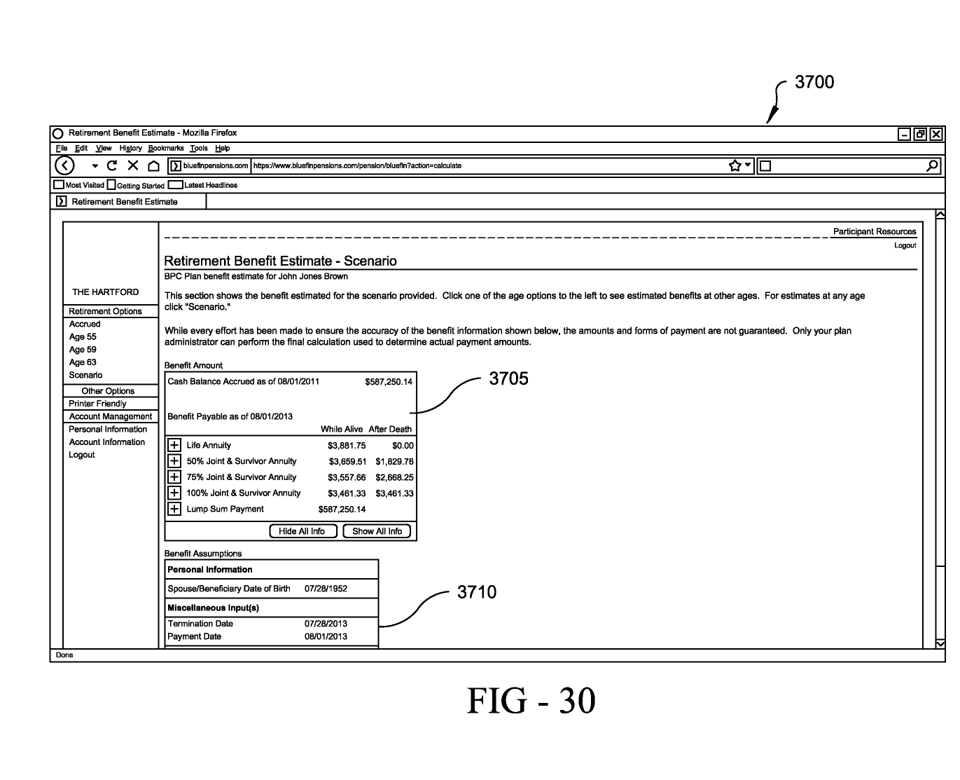

FIG. 30 is an exemplary screen illustrating a retirement benefit scenario available to a participant for an example embodiment of the present invention.

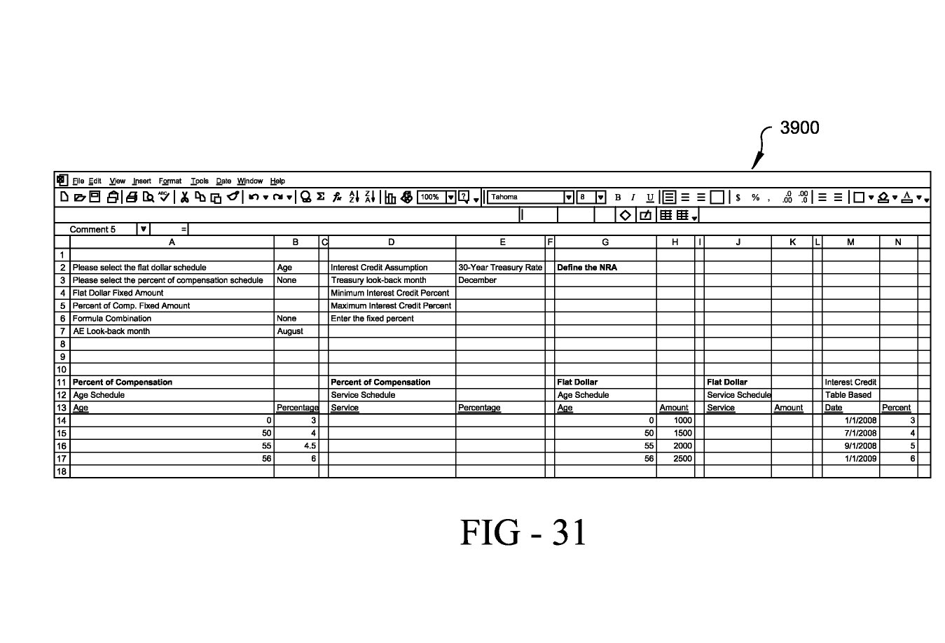

FIG. 31 is an exemplary screen in a spreadsheet illustrating plan definition data captured for an example embodiment of the present invention.

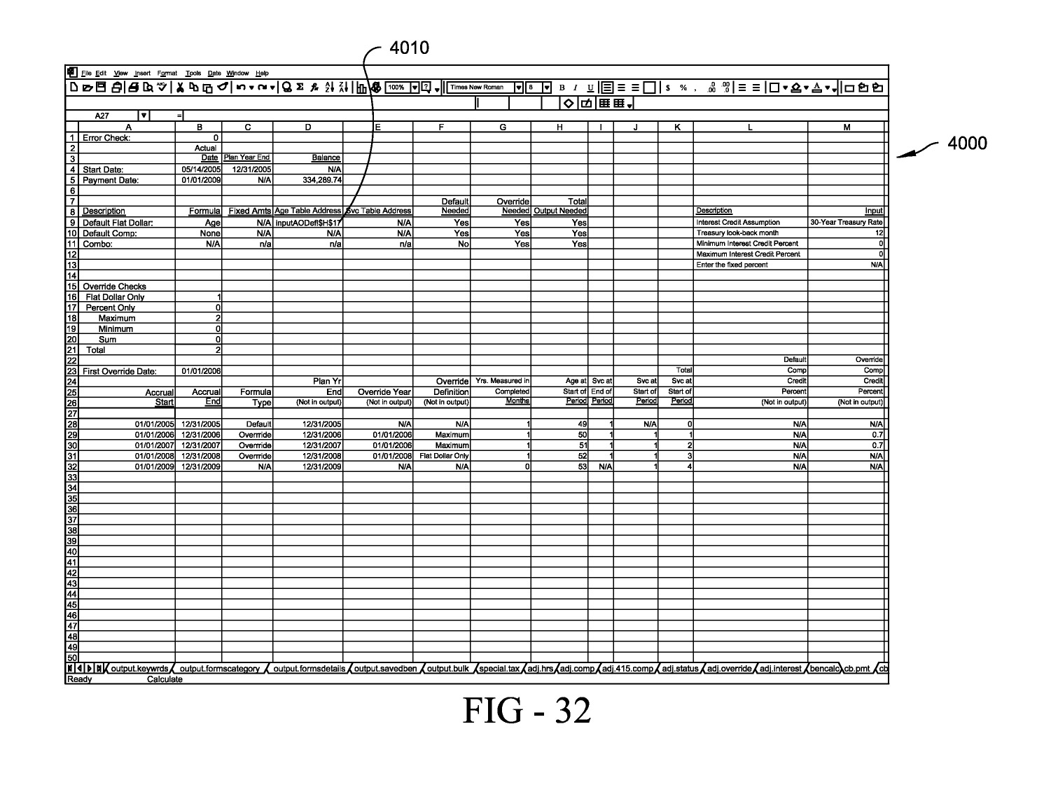

FIG. 32 is an exemplary screen in a spreadsheet illustrating use of data captured on the spreadsheet of FIG. 31 for an example embodiment of the present invention.

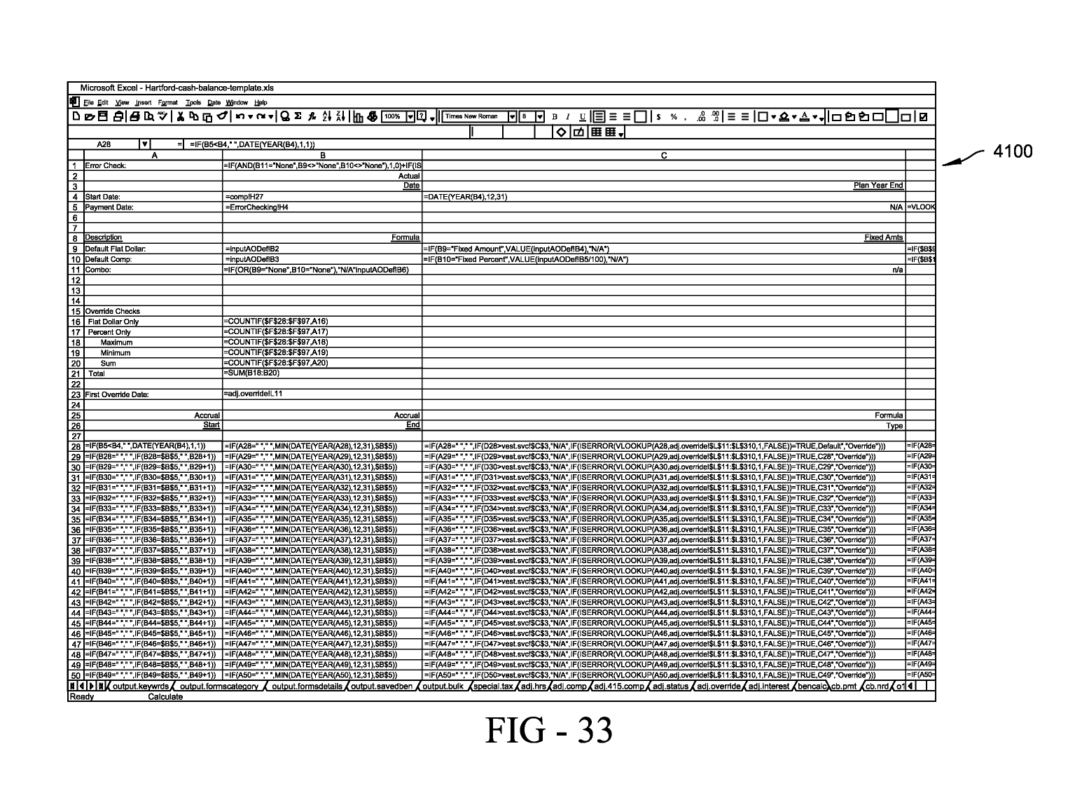

FIG. 33 is an exemplary screen in a spreadsheet illustrating selected formulas in performing plan calculations for an example embodiment of the present invention.

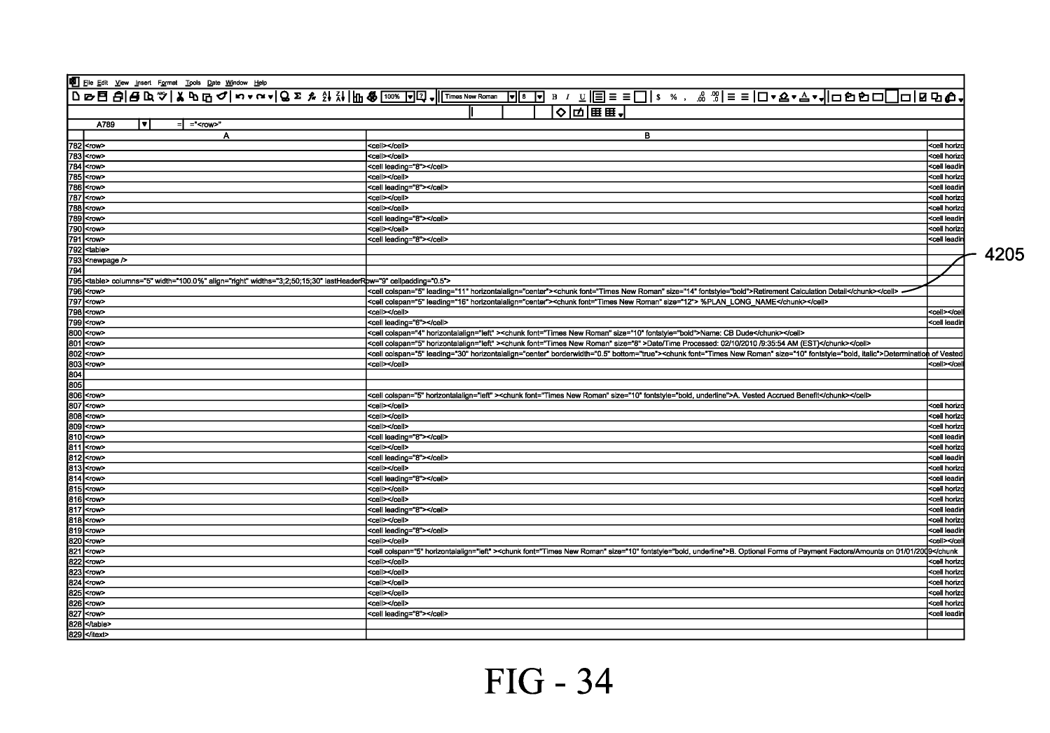

FIG. 34 is an exemplary screen in a spreadsheet illustrating selected code for generating a user-accessible display for an example embodiment of the present invention.

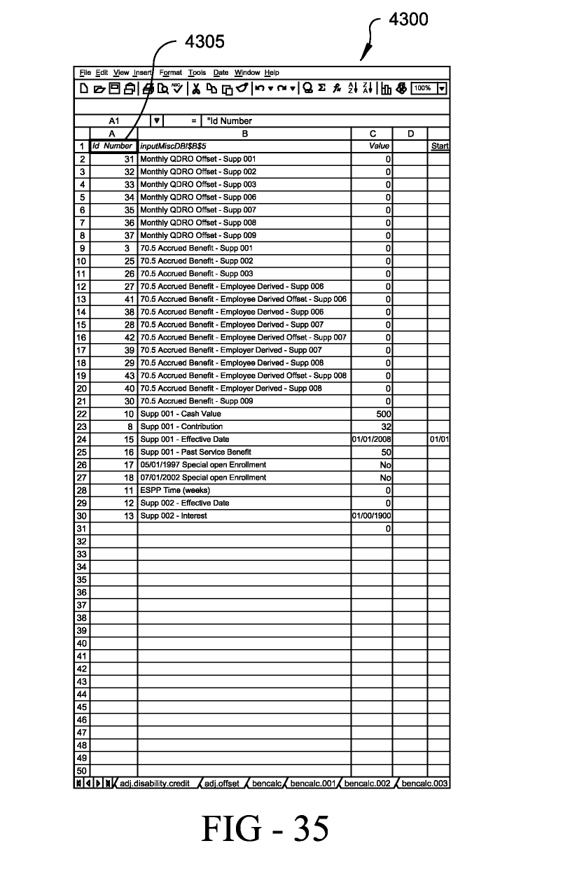

FIG. 35 is an exemplary screen in a spreadsheet illustrating customized data entries for an example embodiment of the present invention.

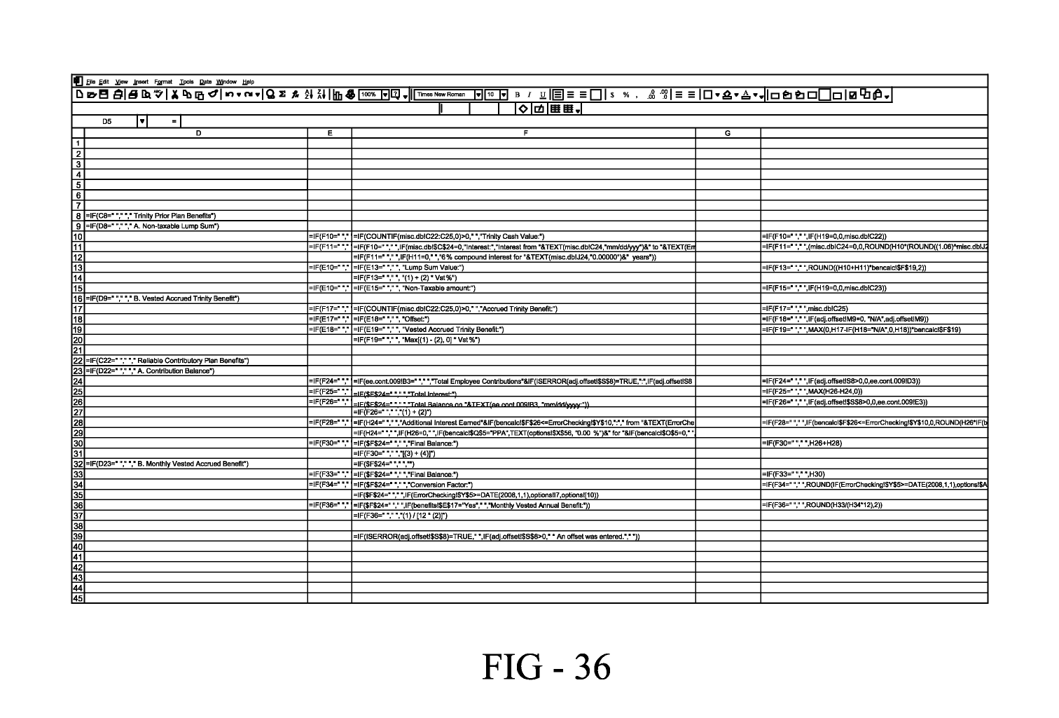

FIG. 36 is an exemplary screen in a spreadsheet illustrating calculations employing the exemplary data of FIG. 35.

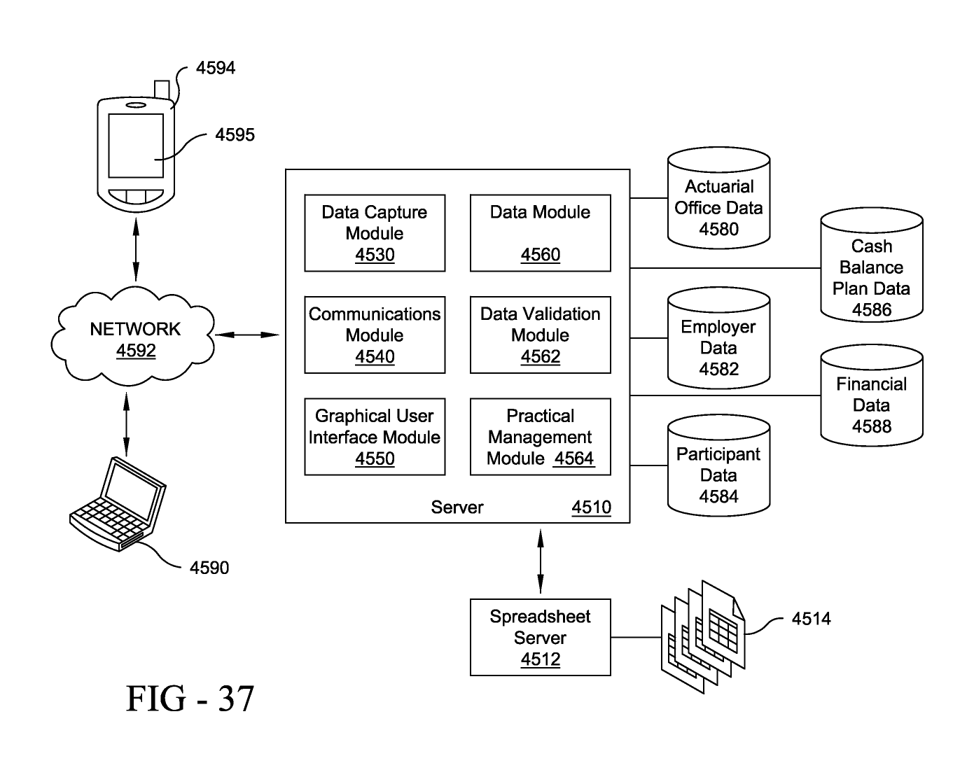

FIG. 37 is an exemplary system for an example embodiment of the present invention.

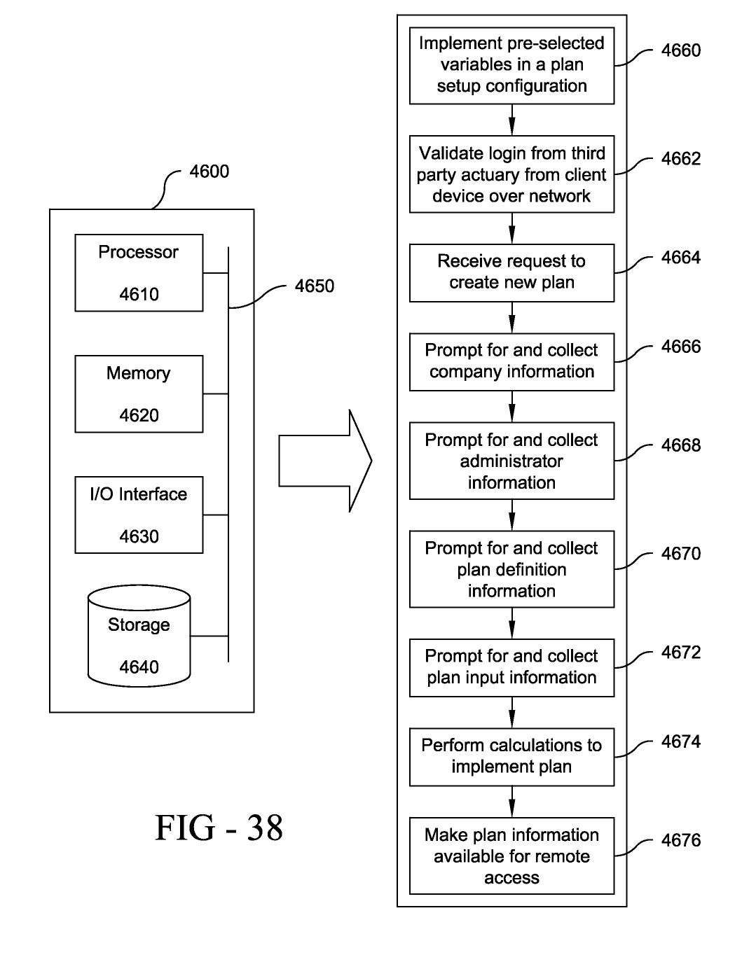

FIG. 38 is an exemplary computer system and method for an example embodiment of the present invention.

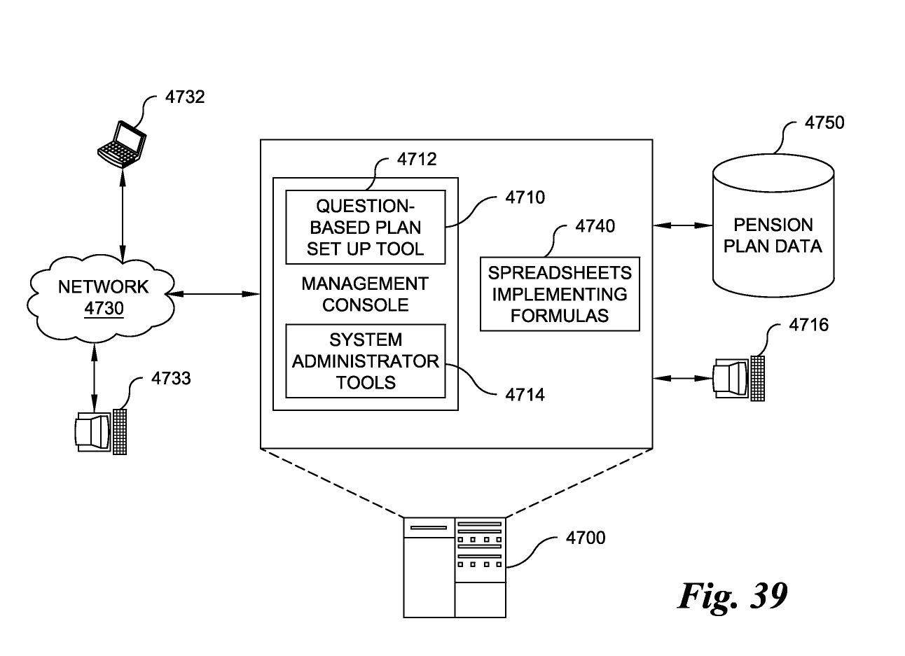

FIG. 39 is an exemplary system for an example embodiment of the present invention.

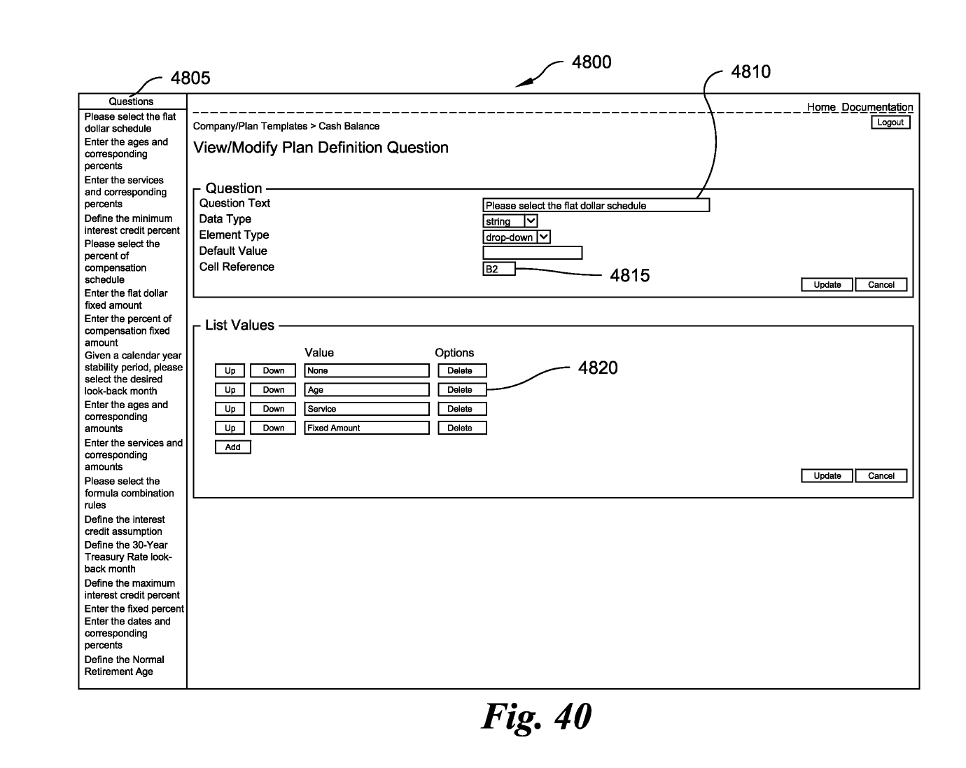

FIG. 40 is an exemplary screen shot of a screen permitting question modification generated by a management console of the system of FIG. 39.

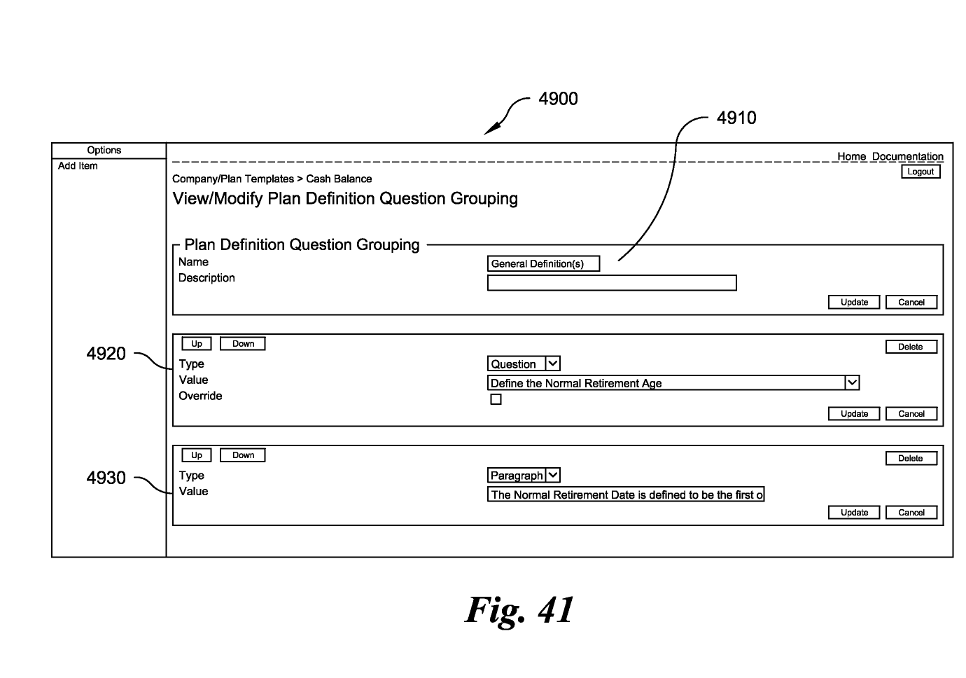

FIG. 41 is an exemplary screen shot of a screen permitting question grouping modification generated by a management console of the system of FIG. 39.

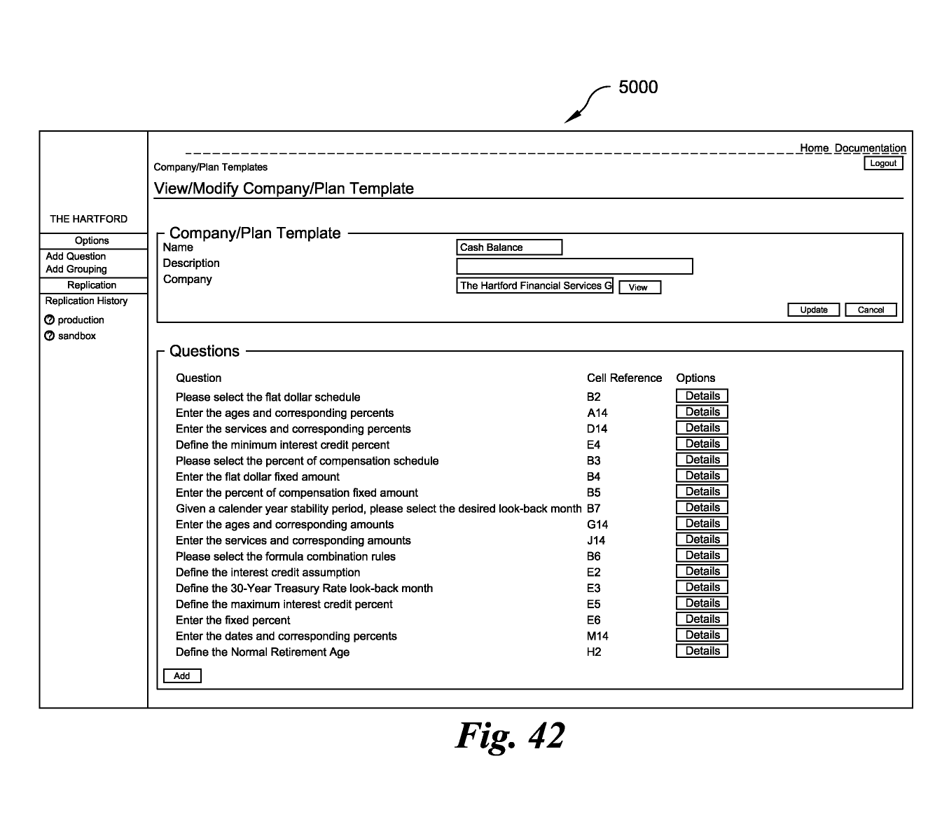

FIG. 42 is an exemplary screen shot of a screen permitting template modification generated by a management console of the system of FIG. 39.

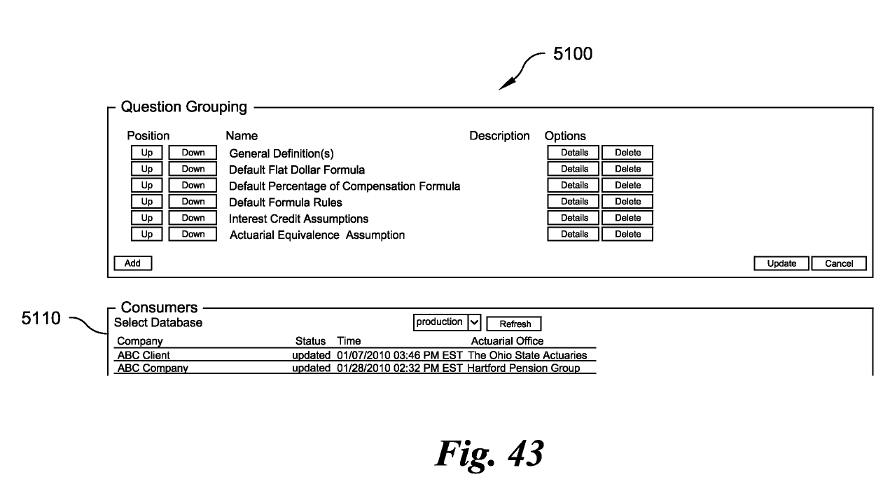

FIG. 43 is an exemplary screen shot of another exemplary screen permitting template modification generated by a management console of the system of FIG. 39.

### DETAILED DESCRIPTION OF EMBODIMENTS OF THE INVENTION

In an embodiment, a system configured for set up and administration of pension plans by a local administrator may be provided. The system may be configured for simplified set up and administration of pension plans using preferences provided by actuaries engaged by plan sponsors. In this embodiment, new pension plans may be set up using predetermined rules by local administrators receiving instructions from outside actuaries. In another embodiment, a system may be configured for set up and administration of defined benefit pension plans, such as cash balance plans, by users accessing a server. In this embodiment, actuaries may directly set up defined benefit pension plans. Multiple templates may be available for use by the actuaries; each template provides a number of options for selection of pension plan provisions. Calculations necessary to implement the plans are linked to a front end tool for selection of pension plan provisions, so that no custom coding is required for set up of new pension plans within the options permitted by each template. In an embodiment, a management console, which may be executed on a hardware server, is configured to permit a system administrator to determine pension plan options available to particular outside actuaries accessing the system and setting up pension plans.

In an embodiment, an on demand real-time Web-based cash balance plan setup and administration system has a hardware server having a plan set up module configured for set up of plans by actuaries engaged on behalf of plan sponsors to set up and administer plans. The actuaries may access the plan set up module from user devices that connect to the hardware server over a network. The plan set up module has pre-defined plan provisions and is configured to receive data from actuaries over a network for establishing new cash balance plans in accordance with selection of one or more of the pre-defined plan provisions. The system may be configured to permit online administrators to be established, and rights of the online administrators, to be defined from the client devices. A rights management module may be provided for establishing online administrators and rights of online administrators. The system may further include a benefit calculations module; a database management module and a trust payment module. All of the modules may be accessible from client devices over a network to users, such as outside actuaries.

In an embodiment, an on-demand real-time pension plan setup and administration system includes a plan setup module for permitting actuaries engaged by plan sponsors to access the system over a network to set up pension plans; a plan setup framework component having pre-defined variable selections related to the plans, the plan setup framework configured to receive input over the network from the actuaries and selections of plan provisions via the plan setup module; a database for storing the actuary input and selections; and a server for executing code adapted to access the database and to implement the input of the actuaries to effectuate set up and administration of multiple pension plans.

In an embodiment, a pension plan creation and administration system accessible from user devices over a network includes a server in communication with a network, the server configured for providing a graphical user interface for prompting a user at a user device to provide data for establishing pension plans; the server further having a processor for performing pension based calculations and a data storage facility for storing data received from the user device via the network and results of the pension based calculations, the pension plan having pre-defined plan provisions adapted for efficient plan setup and administration. The client device may be configured to access the server using a generic client-side device, such as a web browser, to provide data and plan parameter selections to the server for pension plan setup and administration.

A system and method addresses the problems of design and administration of cash balance defined benefit pension plans by providing a remotely-accessible system having a template with complete formulas for implementation of a cash balance defined benefit pension plan. In each template, certain provisions of the plan are fixed and cannot be changed by a user. Other provisions of the plan may be selected by the user, within a limited set of options. Plan provisions that may be selected include those that define default allocation formulas and formulas for crediting the accounts. Individual participant data may be submitted remotely. Default formulas for allocations are applied by the system to individual participants. Authorized users may modify the allocation formulas for each individual participant separately. A calculation engine is provided that performs all of the calculations necessary for administration of each plan, including determining anticipated account balances, and for determining the funding requirements of the plan. The use of a template with a limited number of choices permits actuaries to create plans with a significant amount of flexibility, but to use existing code for calculations, thereby facilitating the set up and administration of plans. As the need for actuaries and programmers to create customized spreadsheets and code for each plan is avoided, customized plans become available even for small employers.

Referring to FIGS. 1-9, an embodiment of a method and system will be described configured for set up and administration of pension plans on a server by local administrators.

Referring to FIG. 1, a block diagram of the primary components for an example embodiment of the present invention is shown. Categories of users of the embodiments shown in FIGS. 1-9 include the following:
Plan Actuary 100” An actuary hired by a company that is sponsoring a pension plan to oversee the management and administration of the pension plan. The Plan Actuary is typically responsible for defining the pension plan, running the valuation report, and certifying it. This term may also refer to an independent or third party plan actuary.
Plan Administrator 102” An employee (typically working in an HR department) of a company that sponsors a pension plan. The Plan Administrator may run benefit calculations, etc for other employees and maintains the underlying database.
Plan Participant 104” An employee of a company and participant of the pension plan.
Developer Actuary” designs the framework of logic and calculations used by the present invention so that Plan Actuaries may define pension plans for their respective companies.

Plan Actuaries, Plan Administrators, and Plan Participants using a computer equipped with a browser may access a web site that provides certain features and functionality of the present invention.

Embodiments of the present invention incorporate tools that allow a Plan Actuary to intuitively setup, administer and define a companys pension plan and thereby automatically generate valuation reports that are compliant with the various federal statutes and regulations. In addition, the Plan Actuary may run benefit calculations for employees. The system is designed so that changes to the plan definition may be made in a single location and affect any other modules that may depend on the change. Modules may be accessible over the web such that Plan Participants, Plan Administrators, and Plan Actuaries may access pension plan information from anywhere and at any time. Plan Actuaries may define plans and generate valuation reports while Plan Participants view their pension benefits and understand what benefits they will receive under a variety of scenarios.

Embodiments of the present invention allow Developer Actuaries to directly contribute to the code for administering the pension plan without requiring them to write a single line of it themselves. This result is accomplished by tools that support logic and calculations. A first tool’ RuleBench’ visually models logic that is stored in a database. A Developer Actuary may visually define the complex logic behind functionality for pension plan definition, calculation sequencing, and report generation in which paragraphs are selected for inclusion in reports. In the calculation sequencing component of the RuleBench, rules may be defined to refer to one or more calculation objects in which complex calculations related to the plan are performed. At any point, the logical structure stored in the database may be converted into expert system code. The expert system code is in turn interpreted by an expert system shell/engine residing on a server. The generated expert system code supports benefit calculations and report generation.

A second tool’ Calculation Designer’ is used to design discrete calculation objects. One method of doing this is to use a standard client-based spreadsheet such as Microsoft® Excel. The calculation objects (e.g., spreadsheets) that are developed with the Calculation Designer may then be sequenced on a server in any manner as dictated by expert system code generated from the calculation sequencing component of the RuleBench. Data may be passed into the calculation objects from a database and/or from calculated results from other calculation objects and subsequently recalculated.

The Developer Actuary 106 uses tools to design the framework of logic (RuleBench component 134) and calculation objects for calculation sequencing (Calculation Designer component 136) provided by the present invention so that Plan Actuaries 100 may define pension plans for their respective companies. The RuleBench component 134 may further comprise a plan definition framework component, a calculation sequencing component, and a report generation framework component. In an example embodiment of the present invention, the RuleBench component 134 and Calculation Designer component 136 may operate on a standalone computer (Microsoft® Windows Client). In an example embodiment of the present invention, the tools operate in conjunction with an expert system shell that provides the functionality defined by the Developer Actuary 106.

The plan definition framework component of the RuleBench component 134 may be used by a Developer Actuary 106 to develop a framework of logic comprising rules and questions that are used to configure presentation conditions and on-screen assistants (i.e., wizards). The rules that are created using the plan definition framework component of the RuleBench component 134 are stored in the RuleBench Data Store 176. The rules relate to a variety of aspects relevant to compliant pension plans. The on-screen assistants created and presented from rules defined using plan definition framework component of the RuleBench component 134 are used in the Plan Definition component 108 by a Plan Actuary 100 to define a plan for a company. The Plan Definition component 108 operates in conjunction with a Plan Definition Generator component 138 and RuleBench Data Store 176 to present the on-screen assistants to the Plan Actuary 100 according to the presentation conditions. Using an interview format, the Plan Actuary 100 communicates through the on-screen assistants and is prompted for answers to questions that relate to a plan. Each on-screen assistant may present one or more questions to a user. Only the questions that are necessary for the plan definition are asked. The answers that the Plan Actuary provides are used in determining which presentation conditions apply and which questions appear on subsequent on-screen assistants. The rules that are developed by the Developer Actuary 106 using the plan definition framework component of RuleBench component 134, therefore, define the sequence of questions that may be asked of the Plan Actuary 100 by the on-screen assistants and are defined so that only relevant questions are posed to the Plan Actuary 100. The plan definition developed by the Plan Actuary 100 in answering questions about the plan provisions is stored at the Plan Data Store 164.

The calculation sequencing component of the RuleBench component 134 may be used by a Developer Actuary 106 to develop a framework of logic for performing (sequencing) calculations defined in calculation objects. Calculations are performed according to the calculation sequence to generate valuation reports and perform benefit calculations for the plan and in connection with requests for information that may be initiated by different categories of users through the web.

The Calculation Designer component 136 may be used by a Developer Actuary 106 to develop calculation objects that contain the complex calculations that are required to support the plan definition. In an example embodiment of the present invention, the Calculation Designer component 136 is a visual tool (e.g., spreadsheet tool) that allows a Developer Actuary 106 to develop calculation objects that are sequenced according to calculation sequencing rules developed using the RuleBench component 134. In an example embodiment of the present invention in which calculation objects are spreadsheets, a calculation sequence is a sequence of rules to select spreadsheets. At runtime, the formulas in the spreadsheets fire as they are selected according to the rules defined by the Developer Actuary 106 using the calculation sequence component of the RuleBench component 134. A spreadsheet server such as the Actuate® e.spreadsheet server may be used at runtime to fire (perform or run) the calculation objects (e.g., spreadsheets) in the sequence specified by the Calculation Store 172.

Code that reflects the sequencing designed by the Developer Actuary 106 is generated and the calculation sequencing rule(s) or instruction code as well as the calculation objects may be stored in the Calculation Store 172. The calculation sequencing rules and calculation objects may be retrieved from the Calculation Store 172 by other components of the present invention to complete complex calculations that may be required to generate valuation reports or to perform benefit calculations.

The report generation framework component of the RuleBench component 134 may be used by a Developer Actuary 106 to develop a framework of logic for generating reports. Using the report generation framework component, the Developer Actuary may define report paragraphs and calculations that may be included in the different types of reports that are generated with the present invention.

The Administration Calculations component 110 may be used by the Plan Actuary 100 or Plan Administrator 102 to generate benefit summaries or benefit scenarios for Plan Participants. The Administration Calculations component 110 uses the Benefit Calculation Engine component 150 to complete the calculations. Data from the Plan Data Store 164 (plan definition), Participant Data Store 174 (Plan Participant data), and Calculation Store 172 is used by the Benefit Calculation Engine component 150 to complete the calculations.

After performing various administration calculations on behalf of a Plan Participant, the Plan Participant may elect to leave the company and take the benefit to which he or she is entitled. The Forms/Election component 128 allows the Plan Actuary 100 or Plan Administrator 102 to generate the forms that the Plan Participant is required to sign to take the benefit. The format and content of the forms are determined by the plan definition from the Plan Data Store 164.

The Valuation Report component 112 may be used by the Plan Actuary 100 or Plan Administrator 102 to generate financial and valuation reports that may be required by law. The Valuation Report component 112 prompts the user for information regarding the type of report to be generated and relevant report parameters such as date ranges or other plan details relevant to the report to be generated. The information provided by the user is used in conjunction with Valuation/Forecasting Engine component 144 and a Report Generator component 146 to generate the requested report. Portions of text that are associated with various types of reports that Plan Actuaries and Plan Administrators are required by law to generate may be developed by a Developer Actuary 106 using the report paragraph component of the RuleBench component 134 and stored in the RuleBench Data Store 176. The plan definition stored in the Plan Data Store 164 dictates which sections of report text appear in the final report and the calculations that are used to generate the financial information included in the final report. A Calculated Data Store 166 holds the data for the calculations that have been completed by the Valuation/Forecasting Engine component 144 (e.g., accrued and projected benefits, vesting status, services, etc.). A Report Email Interface component 148 may be used to send the report to selected recipients (e.g., the Plan Actuary 100 who has requested the report).

The Forecasting Report component 114 may be used by the Plan Actuary 100 or Plan Administrator 102 to generate forecasting reports. The Forecasting Report component 114 prompts the user for relevant report parameters. The information provided by the user is used in conjunction with the Valuation/Forecasting Engine component 144 and a Report Generator component 146 to generate the requested forecasting report.

An advantage of the present invention is that calculations performed in generating valuation reports are certifiable. Valuation reports and other financial reports for pension plans must be certified by an actuary who can confirm that the plan is compliant with the various laws and regulations that govern pension plans. Using known prior art methods, certifiable valuation reports may take months to generate because an actuary must manually gather the relevant data and perform many of the calculations that are required to confirm the plans compliance. Using an embodiment of the present invention, the Valuation/Forecasting Engine component 144 uses calculation sequences developed by the Developer Actuary 106 using the Calculation Designer component 136 to automatically perform the needed calculations.

The Data Edit/Query component 122 allows Plan Actuaries 100 and Plan Administrators 102 to edit or query data related to Plan Participants that may affect various calculations that are performed. The Data Edit/Query component 122 operates in conjunction with the General Data Manager component 156 to provide access to the Participant Data Store 174 and Data Management/Presentation Rulebase 170. The General Data Manager component 156 performs a variety of data integrity checks to ensure that data used for plan calculations is accurate. The user is given the option of correcting the data before proceeding. In some instances, the data discrepancy is not significant, and the user may choose to override the data discrepancy and proceed with the calculations. Examples of errors that may be detected are discrepancies in a Plan

Participants personal data such as a decrease in salary from one year to the next or an employment start date that is earlier than the Plan Participants birth date.

An error checking routine applied to the entire database flags potential errors. They may be queried to quickly locate and correct errors. Errors that are corrected result in elimination of the error flag. If certain data is assumed, this fact may be noted. If an error flag appears but the data is actually correct, this fact may also be noted. Error checking may be performed whenever the database is changed (e.g., when new data is submitted through payroll or when an individual record is changed). If a record is accessed, the list of potential errors is illustrated. Once again, these errors may be corrected, assumed data may be added and noted as such, or the system may be told that the data showing the potential error is actually correct. Fatal errors exclude a record from consideration on a valuation run, benefit calculation, or other such calculated item.

The Trust Direction component 124 operates in conjunction with the Trust Direction Manager component 140 and Trust Interface component 142 to allow a Plan Actuary 100 or Plan Administrator 102 to communicate with a plan trustee who is responsible for distributing benefits to Plan Participants. The Trust Direction component 124 allows the user to enter instructions related to payment instructions, including benefit amount, withholding and other deductions.

The Payroll Data Upload component 126 operates in conjunction with the Bulk Data Manager component 158 and Payroll Data Email Interface component 160 to upload payroll data.

The Login/Password/Setup account component 116 may be used by a Plan Actuary 100 or Plan Administrator 102 to establish accounts for users of the system including Plan Participants. In an example embodiment of the present invention, accounts for Plan Participants are self-activating. Personal information for each Plan Participant (e.g., contact information, salary information, etc.) is loaded in the Participant Data Store 174 and user data is loaded in the User Directory 168. Plan Participants who wish to establish an account so that they may access plan data through the web complete a simple procedure to activate their accounts. For example, the account may be activated when a participant provides a social security number and creates a password. They are not required to enter the contact and other information that is needed to perform benefit calculations and benefit scenarios on their behalf. The Authentication Manager component 154 controls user access to the system in accordance with user data in the User Directory 168.

The Participant Calculations component 118 may be accessed by Plan Participants so that they may review personal information, plan summary information, and a retirement planning calculator. The calculations that may be performed include benefit summaries and benefit scenarios related to retirement benefits, death benefits, and disability benefits.

A Plan Participant 104 may enter parameters relating to various benefit scenarios and obtain an immediate response indicating the benefit to which the participant is entitled under the scenario. For example, the participant may inquire about the benefit to which he or she would be entitled at retirement ages of 55, 60, and 65. In another example, the participant may inquire about the benefit to which he or she would be entitled for a retirement age of 60 and salary increases of 5% every year until retirement age.

The Benefit Calculation Engine component 150 performs the complex calculations using data from the Plan Data Store 164 (the plan definition), the Calculation Store 172 (calculations for the defined plan), and Participant Data Store 174 (participants salary history, etc.). If the Plan Participant decides to take advantage of the benefit, he or she may request the appropriate forms to be signed. The Forms/Election component 128 allows the Plan Administrator to generate the necessary forms. The format and content of the forms are determined by the plan definition from the Plan Data Store 164.

The Retirement Planning component 130 may be used by a Plan Participant. It considers the pension plan, any defined contribution plans, social security, and other retirement income or savings in performing calculations for the benefit of the Plan Participant. The Retirement Planning component 130 projects retirement income expected and provides a plan to reach targets. The information needed by the Retirement Planning component 130 may be obtained from the Plan Participant through an interview process.

The Summary Plan Definition (SPD) component 120 allows a Plan Participant 104 to see a summary of the pension plan. The summary may be obtained from the SPD/Static Content Repository 178.

Other components that operate to provide the features and functionality of the present invention are the Presentation Manager component 180 (to manage the presentation of screens to users), a Workflow Engine component 182 (to manage user interactions between components), and a Relational Database Management System/File System component 184 (to manage interactions with data stores and files). The Presentation Manager component 180 operates in conjunction with the Data Management/Presentation Rulebase 170 and SPD/Static Content Repository 178.

Referring to FIG. 2, the plan definition framework tab of a RuleBench screen 200 for a RuleBench component in accordance with an example embodiment of the present invention is shown. The plan definition framework may be designed and created by a Developer Actuary. The plan definition framework tab comprises an organizational section 202 that displays the three main elements for defining the plan definition framework:
Folders which are used to contain and organize other elements within the same category;
Question elements that may be presented to a Plan Actuary 100 through the Plan Definition Generator 138 in a variety of formats; and
Rule elements which describe conditions that questions must meet in order to be presented (presentation conditions).

As shown in the organizational section 202, folders related to the plan definition framework are organized hierarchically in a series of folders. In an example embodiment of the present invention, top-level folders may relate to valuation setup 204 and plan provisions 206. Each top-level folder may comprise one or more sub-folders, and each sub-folder may comprise additional folders. For example, within the plan provision folder 206, sub-folders of plan participation, service, vesting, normal retirement, early retirement, disability retirement, delayed retirement, salary, and benefits formulas may be created. Within the salary sub-folder, salary definitions and annualized salary folders may be defined. The Developer Actuary has full control over the hierarchy of folders and may define as many folders and sub-folders as are necessary to obtain from users the information that is needed to define the complete plan. In addition, the Developer Actuary can add and remove rules and related questions from folders and sub-folders as needed. Questions within a given folder are presented to a Plan Actuary 100 through the Plan Definition Generator 138 if the condition for each rule within that folder has been met as well as those for each of the other folders that is inherited by virtue of its location inside the hierarchy.

The question section 208 shows the name and identification number of a highlighted element that has been highlighted in the organizational section 202. The affected rules section 210 shows which rules are dependent upon the highlighted element in section 202. The precedent folders section 212 shows the inherited folders from organizational section 202.

A Developer Actuary has the ability to add or modify questions or rules (presentation conditions) for the plan definition framework at any time as shown by FIGS. 3 and 4. Referring to FIG. 3, an add question screen 300 for an example embodiment of the present invention is shown. A Developer Actuary may enter question details such as question text and notes that relate to the question. In addition, the Developer Actuary may specify whether a question is required or optional. The Developer Actuary may also specify a question type. The question type indicates how the question is presented to the Plan Actuary during plan definition. Some questions may require input from the Plan Actuary (e.g., a date). In other instances, the Plan Actuary may be able to select an answer from a list of answers applicable to the question by scrolling through the appropriate answers or by selecting a button associated the appropriate answer.

Referring to FIG. 4, an add new plan rule screen 400 for an example embodiment of the present invention is shown. With the add new plan rule screen, the Developer Actuary may define the presentation conditions that apply to a selected question. The Developer Actuary may specify a description of the rule, a reason for the rule (Reason Text), and rule conditions (Rule Conditions). Each rule condition may have a condition identifier, the text of the question to which the rule applies, an operator, and related value. Examples of operators include equal to, greater than, and less than. Comparison values may relate to values for answers to questions that were answered by a Plan Actuary previously. The answer values may relate to responses regarding time as well as replies of yes or no.

Referring to FIG. 5, a calculation-sequencing tab of a RuleBench screen in accordance with an example embodiment of the present invention is shown. In calculation sequencing, the Developer Actuary may select calculation objects and define the rules that apply to them when they are run as part of a benefit calculation or valuation report. Calculations are discrete and are performed in a sequence to generate valuation reports and benefit calculations for the plan and in connection with requests for information that may be initiated through the web. For example, Plan Actuaries may submit requests for benefit calculations using specific participant data. In addition, Plan Participants may submit requests for benefit calculations based on their own individual situations and employment histories. Different kinds of calculations are often used for different plans. The calculations sequencing component of the RuleBench allows the Developer Actuary to define the calculations that apply to the defined plan and in what sequence they are used.

The calculation sequencing screen 500 comprises an organizational section 502 that displays the three main elements for defining the sequence of calculations:
Folders which are used to contain and organize other elements within the same category;
Discrete calculation objects that are defined using the Calculation Designer; and
Rules that describe conditions that apply to the calculation object.

As shown in the organizational section 502, calculation objects are organized hierarchically in a series of folders. In an example embodiment of the present invention, top-level categories of calculation objects relate to Normal Retirement Date 504, Service, Break in Service, Early Retirement Date, and Vesting. Each top-level folder may comprise one or more sub-folders, and each sub-folder may comprise additional folders. For example, within the Service folder, a sub-folder may be created. The Developer Actuary has full control over the calculation object hierarchy and may define as many folders and sub-folders as are necessary to perform calculations based on user requests for benefits information and report generation. In addition, the Developer Actuary may add and remove calculation objects from folders and sub-folders as needed.

The rule section 506 shows the identification number and name of a rule that is associated with a selected calculation object. The Plan Conditions section 508 shows which questions are associated with the selected calculation object. The Plan Conditions may comprise an identifier for a question, question text, and operand and values indicating when the calculation of the calculation object applies to the displayed question.

Referring to FIG. 6, a report framework tab of a RuleBench screen for a Report Generator component in accordance with an example embodiment of the present invention is shown. The Developer Actuary may define report paragraphs and calculations that may be included in the different types of reports that are generated with the present invention. As indicated in FIG. 6, with the report framework screen 600 the paragraphs are organized in report format. For example, report headers 602 may be defined and individual paragraphs may be defined. Individual paragraphs may relate to a title page 604 or parts of the report 606. In the question section 608, the Developer Actuary may associate questions with the individual report paragraphs, and in the report rules section 610, identify the rules that apply. The plan definition developed by the Plan Actuary determines which report paragraphs are selected individually to be included in a generated report.

An expert system code generator uses the output of the plan definition framework component, calculation sequencing component, and report framework component to generate code for the features and functionality of the present invention. The code provides the features and functionality available to the Plan Actuaries, Plan Administrators, and Plan Participants over the web. When the Developer Actuary changes the plan definition framework, calculation sequencing, or report framework, new code reflecting the changes may be generated and made available. JAVA Expert System Shell (JESS) is an example of an expert system shell that may be used to execute the expert system code generated by the present invention.

Plan Actuaries may access the system and method of the present invention to perform a variety of tasks. A Plan Actuary page is displayed when a user recognized as a Plan Actuary logs in. Typically, in addition to Plan Actuary functions, Plan Administrator functions are also available to Plan Actuaries. Additionally, the Plan Actuary may define a plan and generate actuarial valuation reports.

Referring to FIG. 7, a plan definition screen for an example embodiment of a plan definition component in accordance with an example embodiment of the present invention is shown. Within the various categories of questions that relate to pension plan definitions, the Plan Actuary is presented with questions to be answered. For example, in the Valuation Set Up category 700, questions related to the valuation date 702, first day of the plan year 704, actuarial method changes 706, fiscal year end for contributions 708, and measuring of plan amendments may be asked. In addition to viewing the plan definition in a question format, the Plan Actuary may view the plan definition in an outline format 712 that shows the various categories and sub-categories (i.e., folders) of questions in the plan.

An authorized Plan Actuary may set up a plan or modify it under the plan definition component. All plan provisions (including details like rounding rules) are captured through an intelligent interview process. The Plan Actuary is prompted for answers to questions about the provisions of the plan. By answering the questions that are posed, the Plan Actuary may define a limitless series of provisions that identify exactly the specific plan that applies to the company. If necessary, provisions may be defined differently for each Plan Participant. Plan assumptions and methods are also included, as well as previous year valuation results and asset information. All the input is aggregated and the valuation/reporting engine and the benefit calculation engine are run with the output being unique to the provisions of a given pension plan.

Once the plan definition is entered, and the company database (e.g., plan participant data, payroll data, etc.) has been loaded, all information needed for a valuation is available. If changes need to be measured (such as plan amendments, assumption changes, or method changes), the Plan Actuary may define the order in which these items are valued. The valuation/reporting engine then measures the changes and generates the valuation report. Plan liabilities are calculated directly without shortcuts. Pre-retirement death after termination or disability is included. Data for any number of Plan Participants may be included in the valuation with details to verify results. Individual calculated liabilities, benefits, etc. are stored in a database and may be queried to assist in the Plan Actuarys review. After completion, the valuation report is emailed to the Plan Actuary.

Plan Administrators may also access the system and method of the present invention to perform a variety of tasks. A Plan Administrator page is displayed when a user recognized as a Plan Administrator logs in. Typically, the tasks that Plan Administrators perform include benefit calculation/projection capabilities for each benefit type (retirement, disability, pre-retirement death, etc.), data management, financial reporting, and trust payment direction.

The Plan Administrator may perform benefit calculations for any participant in the plan. The Plan Administrator selects the participant using a search engine and then selects a benefit type. A summary page similar to the summary provided for Plan Participants is shown. If a specific calculation or projection is needed, all of the pertinent data is displayed and may be changed for purposes of completing the desired calculation. The output is similar to the information provided for Plan Participants. Additional scenarios may be calculated or forms may be generated that are specific to each calculation. For example, if a retirement calculation is performed, the forms that are generated are those needed for the participant to retire. If a vested terminated calculation is performed, a notice of vested benefits is generated.

In an example embodiment of the present invention, when a benefit type is accessed (e.g., retirement benefits), a summary is provided illustrating four different benefits. The summary illustrates four different benefits. An accrued benefit is calculated. Two early retirement benefits are calculated and the normal retirement benefit is calculated. Any future benefits are determined initially using a 0% future salary increase assumption. The Plan Participant may change this assumption and the same four benefits are then calculated using the input salary increase assumption. The benefits are shown in the normal form of payment under the plan. Referring to FIG. 8, a benefit summary” retirement screen for an example embodiment of the present invention is shown.

For a specific benefit projection, the user may provide a date of termination, date of retirement, salary increase assumption, spouse/beneficiary birth date, and any other plan specific item needed (for example, if social security level options are permitted under the plan, a social security retirement date is requested so that this option may be calculated). The benefit is then calculated based upon these inputs. Optional forms of payment are also illustrated. If the scenario supplied by the Plan Participant is not valid, a message is displayed indicating that the input is not valid or the input will be revised (for example, if a payment date is prior to a termination date, the payment date is adjusted to reflect the termination date). On the output page, the scenario input used in the calculation is displayed. The user may then choose to project another scenario or may move on to another function. Referring to FIG. 9, a benefit scenario results screen for an example embodiment of the present invention is shown.

Plan Administrators may also perform data management tasks. The present invention maintains a complete pension database. All applicable data elements necessary to determine benefits for Plan Participants are stored. Plan codes, company codes, location codes, employment codes, department codes, etc., are available to help identify various groups. Addresses, beneficiary data, benefit elections, retirement check deductions, etc. is included. Inactive participant information is stored. In addition, many calculated items such as accrued and projected benefits, vesting status, services, etc., may be stored.

The Plan Administrator has the ability to query the databases for any data element(s) or to produce any reporting needed for participant notification, etc. Data items are selected to define the group for the query and then the data elements to be listed in the output are identified. Alternatively, the Plan Administrator may review/edit the data for one participant. The Plan Administrator also has the ability to download data.

The Plan Administrator has the ability to project up to three years of contributions and financial statement expenses for different interest rate and asset return assumptions the user selects. These projections may be executed assuming no other gains or losses (other than interest rate and asset return changes). The basis for these projections is the last valuation that was completed.

Plan Participants may also access the system and method of the present invention to perform a variety of tasks. The Plan Participant may access a summary plan description or any other plan summary. Links to specific terms in the summary may provide additional definitions and more detailed explanations regarding the plan.

A Plan Participant may perform retirement planning tasks using the retirement planning component which considers the pension plan, any defined contribution plans, social security, and other retirement income or savings to project retirement income expected and provide a plan to reach targets. The information needed by the retirement planning component may be obtained from the Plan Participant through an interview process. In an embodiment, a Plan Participant may request a retirement package by inputting data similar to that requested in the retirement scenario projection. This response to the request includes all forms necessary to effect retirement. In an embodiment, rights to request a retirement package may be not be provided to Plan Participants, but Plan Administrators may have rights to request a retirement package.

Multiple companies may take advantage of the present invention. The modular design and implementation supports the customization of the presentation functionality so that a company logo or identifier is associated with each screen the user sees. The security and authorization mechanisms that are employed ensure that only the functions authorized for use by a particular user may be accessed. The system and method automatically associates each user with the correct pension plan and displays only information that is applicable to the plan and the users authorization.

Embodiments of the present invention may be embodied as a web-based system and method that provides real-time pension plan setup/creation and administration for Plan Actuaries, Plan Administrators, and Plan Participants. Reports and calculations that now take weeks or months to generate may be performed instantly with the present invention. Because employee information is updated when plan definitions change or payroll data is updated, results are always current. Users may perform an unlimited number of calculations, reports, and transactions resulting in significantly lower administration costs. Any company or other employer that has a pension plan may benefit from using the system and method of the present invention.

In an embodiment, a system and method are provided for creation and administration of cash balance pension plans on a server accessible over a network from a user device. An outside actuary engaged by a plan sponsor may access the server from a user device to create and administer cash balance pension plans on behalf of the plan sponsor. This embodiment is generally described with reference to FIGS. 10-46.

Cash balance plans are many times used by business owners who find that a 401(k) plan alone may not meet all of their retirement plan needs. Cash balance plans may offer increased benefits under applicable statutes and regulations for a company and a substantial increase in employer contribution levels. Some benefits of a cash balance plan for a business include: potential for increased regulatory benefits; enhanced ability to recruit and retain key employees; addressing existing qualified plan compliance testing failures; and implementing plans for business succession. Benefits for owners and key employees include: accelerated accumulation; higher employer contribution limits compared to other types of plans; ability to configure plans to permit greater contributions for owners and/or key employees; and growth in value. For employees benefits may include: employer contributions; ease of understanding, particularly compared to traditional defined benefit plans; portable nature of vested account balances, permitting such balances to be rolled into another qualified plan or IRA upon termination or retirement; potential for accelerated accumulation; and potentially creating an asset protected from creditors in the event of bankruptcy or judgments.

Referring to FIG. 10, an arrangement 1000 in which a method and system according to an embodiment of the invention may be employed is shown. Server computer 1002 provides computing resources, such as in client server mode or application service provider form, for creation and administration of cash balance pension plans. Server computer 1002 is in communication via communications network 1004, which may be or include the Internet, with actuaries 1010, 1030, 1050. Actuary 1010 employs desktop computer 1012 to access server computer 1002 via network 1004 to create and administer cash balance pension plans. The cash balance pension plans are created and administered on behalf of employers having personnel. Actuary 1010 is shown having exemplary clients, particularly manufacturing employer 1014, retail employer 1020, and office-based employer 1024. Manufacturing employer 1014 has personnel 1016. Some or all of personnel 1016 participate in a cash balance pension plan created and administered by actuary 1010 using resources of server computer 1002. Retail employer 1020 has personnel 1022. Some or all of personnel 1022 participate in a cash balance pension plan created and administered by actuary 1010 using resources of server computer 1002. Office-based employer 1024 has personnel 1026. Some or all of personnel 1026 participate in a cash balance pension plan created and administered by actuary 1010 using resources of server computer 1002.

Actuary 1030 employs smartphone 1032 to access server computer 1002 via network 1004 to create and administer cash balance pension plans. Actuary 1030 has exemplary clients, including retail employer 1036 having personnel 1038 and factory employer 1040 having personnel 1042. Some or all of personnel 1038 participate in a cash balance pension plan created and administered by actuary 1030 using resources of server computer 1002. Some or all of personnel 1042 participate in a cash balance pension plan created and administered by actuary 1030 using resources of server computer 1002.

Actuary 1050 employs laptop computer 1052 to access server computer 1002 via network 1004 to create and administer cash balance pension plans. Actuary 1050 has exemplary clients, including warehouse employer 1056 having personnel 1058 and factory employer 1060 having personnel 1062. Some or all of personnel 1058 of warehouse employer 1056 participate in a cash balance pension plan created and administered by actuary 1050 using resources of server computer 1002. Some or all of personnel 1062 of factory employer 1060 participate in a cash balance pension plan created and administered by actuary 1050 using resources of server computer 1002.

Referring to FIG. 11, features of a system according to an embodiment are shown. An exemplary computer system 1100 for use in an implementation of the invention will now be described. In computer system 1100, processor 1110 executes instructions contained in programs such as cash balance pension plan set up and administration application program 1112, stored in storage devices 1120. Storage devices 1120 may include suitable media, such as optical or magnetic disks, fixed disks with magnetic storage (hard drives), tapes accessed by tape drives, and other storage media. Processor 1110 communicates, such as through bus 1102 and/or other data channels, with network access unit 1105, system memory 1130, storage devices 1120 and input/output controller 1125. Via input/output controller 1125, processor 1110 may receive data from user inputs such as pointing devices, touch screens, audio inputs and keyboards, and may provide data to outputs, such as data to video drivers for formatting on displays, and data to audio devices. Storage devices 1120 are configured to exchange data with processor 1110, and may store programs containing processor-executable instructions, and values of variables for use by such programs. Storage devices 1120 may include local and network accessible mass storage devices. Storage devices 1120 may include media for storing operating system 1122 and mass storage devices such as cash balance pension plan account data storage 1124 for storing data related to cash balance pension plans, such as participant identification data, rule data, balance data, contribution data, rates for crediting balance increases, and other data. In an embodiment, inputs may include user interfaces, including workstations having keyboards, touch screens, pointing devices such as mice, or other user input devices, connected via networked communications to processor 1110. Network interface unit 1105 may communicate via network 1150 with remote sources of data, actuary computer systems, plan participant computer systems, employer computer systems, and with systems for implementing instructions output by processor 1110. Network 1150 may be or include wired or wireless local area networks and wide area networks, and over communications between networks, including over the Internet. Any suitable data and communication protocols may be employed.

A system and method for set up of cash balance pension plans will be illustrated. Referring to FIG. 12, a screen is shown that is generated by a system server in response to a user device, such as a computer system of an outside or independent actuary, providing a signal to gain secure access to server computer 1002 of FIG. 10. In the following examples, the system is implemented in a browser based system, and particularly in Microsoft Internet Explorer. However, other browsers and other client-server arrangements may be employed. It will be appreciated that all of the screens illustrated herein may be displayed on any type of client device, including desktop computers, laptop computers, smart phones, PDAs, Internet enable televisions, and other devices. Referring again to FIG. 12, the system generates a screen 1200, which prompts the user to provide user identification information at field 1202 and password data at field 1204. The browser then transmits the credentials to the system for authentication.

Referring to FIG. 13, a screen 1300 is displayed generated by the system for display on a users browser. Screen 1300 is provided to those authenticated users in a class of users identified as administrators. Rules stored in storage devices and implemented by the system cause different initial screens to be displayed to other classes of users, such as plan participants and employer representatives. An administration module may generate initial screen 1300. Administrators may include users such as outside or independent actuaries. From screen 1300, an administrator may enter a benefit calculation module 1302, database management module 1304, trust payment module 1306 and administration module 1308. Administration module 1308 permits a user to parameterize a new plan. In embodiments of the present invention, as discussed in more detail later herein, a number of the plan parameters are predetermined in an intuitive and efficient manner to speed plan setup. In embodiments, the predetermined plan parameters may be embodied in one or more templates. Upon selection of plan set up, a user may have access to a plan set up module configured to received data from a user, such as an outside actuary, for establishing a new plan, such as a new cash balance plan, in accordance with one or pre-defined plan provisions. If more than one template is accessible employing administration module 1308, a user may be prompted to select one of the accessible templates. The plan set up module may be server based, and the user may employ a client device for interaction with the server, the client device configured to provide data and plan parameter selections to the server for pension plan setup and administration.

The system may include a rights management module for establishing one or more online administrators and defining rights of the online administrators. In an embodiment, a plan set up framework component having pre-defined variable selections related to the plans defined by the actuary, may be provided. The plan setup framework may be configured to receive independent actuary input and selections via the plan setup module.

Referring to FIG. 14A, a user will be provided with an actuarial office data screen 1400 for providing basic information regarding an actuarial office at office information section 1402. Suitable fields are provided at 1404 for modifying name and address information. A history button 1406 provides access to data stored in the system concerning prior office data, such as prior addresses. An update button 1408 permits new data to be stored as current data. Prior data is retained in the system and designated as historical data. The system identifies individual administrators of plans for the actuarial office in primary administrator section 1410. The user of the screen in the example of FIG. 14A does not have rights to modify the primary administrators. The companies on whose behalf plans have been set up, or are in the process of being set up, are shown in companies section 1414. Selection of the new company button 1416 causes the system to provide a company screen, shown and described below with respect to FIG. 15. Turning to FIG. 14B, which is a continuation of the actuarial office screen 1400, administrator section 1420 is populated with system data identifying all individual administrators associated with the actuarial office in the system database. A new administrator button 1422 launches a tool that prompts the user for data for additional individual administrators. Administrator groups section 1426 is populated with data identifying groups of administrators from a system database. Administrators may be grouped for convenience. Different groups may be associated with different companies, for example. A new administrator group button 1428 launches a tool that prompts the user for data for defining new administrator groups.

Referring to FIG. 15, in response to selection of one of the companies associated with the actuarial office in company section 1414 of FIG. 14, a company information page 1500 is generated. The company information page permits a user to view and edit various categories of information in the system database related to that company, including company information 1502, information on plans of the company 1504, plan definition data 1506, and administrator rights 1508. Company information section 1510 displays the selected template 1512 employed for set up and administration of the companys plan. Company name and address information may be provided as shown generally at 1514. Company administrator section 1516 lists those administrators associated with the company, and permits addition and deletion of administrators associated with the company.

Referring to FIG. 16, there is shown a plan setup screen 1600 for creating a new cash balance plan or modifying an existing plan. The user may select or update a plan name and a short name. An identification number associate with the plan, referenced here as a TRAC ID, may input at field 1610. The user may choose whether to permit access by individual plan participants by selecting or deselecting check box 1612. The TRAC ID or other identification number may be common to other retirement plans of the same company, such as 401(k) plans or other defined contribution plans, or defined benefit plans. The use of a common identification number can be employed to provide a common login for participants to obtain individual account data regarding cash balance plan administered under the present system and other plans administered by other providers. An individual that serves as a plan contact, who may be an independent actuary, may be added to the system database at 1614.

Referring now to FIG. 17, a plan definition screen 1700 for defining provisions of a cash balance plan is shown. The plan definition screen 1700 is accessed using the plan definition button 1506 of FIG. 15. The plan definition screen 1700 provides a user with a number of choices of plan definitions. The available choices are predetermined depending on the template selected by the user. In the example of plan definition screen 1700, a normal retirement age may be selected from a limited number of ages from a retirement age drop down menu 1702. The template defines the normal retirement age as the later of the selected defined age and the fifth anniversary of the date of participation of the plan participant. The available defined ages are limited to four defined ages in this template.

Referring now to FIG. 18, the selection of options in the default flat dollar formula section 1710 of plan definition screen 1700 will be described. A default flat dollar formula is an available option for defining the contributions made by plan participants in a cash balance pension plan. In the flat dollar schedule drop down menu 1712, the available options are none, age-based formula, a service-based formula, or a fixed amount. Referring to FIG. 17, if a fixed amount has been selected from flat dollar schedule drop down menu 1712, then a fixed dollar amount input field 1714 will accept a numerical amount. The flat dollar schedule is based on a flat dollar amount for a predetermined interval, such as a monthly interval. If service years are selected from flat dollar schedule drop down menu 1712, then a service years chart 1718 is presented to the user, as shown in FIG. 18. The user may select two or more service years and, for each service year, a corresponding amount that is contributed to the plan starting in that service year.

If age is selected in the flat dollar schedule drop down menu 1712, then an age and corresponding amount chart, similar to the service years chart 1718, is generated by the system. The user may select two or more ages and, for each age, a corresponding amount that is contributed to the plan starting at the indicated age.

Referring to FIG. 19, a default percentage of compensation formula dropdown menu 1721 is shown. The drop down menu includes options for no contribution based on percentage of compensation, age-based variation, service based variation, or a fixed percentage. Selection of a fixed percentage option causes the system to prompt the user for a numerical input by displaying a single field form 1722 (shown in FIG. 18). Responsive to selection of the age-based option, the system provides a chart for age and percentage amount, similar to service years chart 1718 of FIG. 18.

Referring to FIG. 21, a drop down menu 1726 is shown for selection of rules for combinations of flat dollar and percentage of compensation formulas. The options include summing the amounts from the formulas, taking the maximum of the amounts from the formulas, or taking the minimum of the amounts from the formulas.

Drop down menu 1728 is provided to permit a user to specify interest credit assumptions. The account balances in the plan are credited according to the selected interest credit assumptions. The options are a fixed percent which may be specified by the actuary, a table of percentages which may be created by the actuary, or an available rate or index, which in this example is the 30-Year Treasury Rate.

Referring to FIG. 22, user selection of table in drop down menu 1728 causes the system to present a blank table 1730 with fields for input of two or more interest rates and an associated date that each interest rate will begin to be credited. The system is configured to reduce or increase the number of interest rate/begin date field pairs responsive to user selection of a delete button 1732 or add button 1734, respectively.

The system is configured to provide a user with a drop down menu 1736 from which a look-back month may be selected. The look-back month is selected for actuarial equivalence assumptions used to convert a cash balance in a participant account to an annuity. The system is further configured to prompt a user to provide selected retirement ages available for calculation by providing a user with fields 1740 for receiving potential retirement ages. The selected ages will be available for input by participants in projecting cash balance amounts and retirement income amounts. As the calculations involved for each age are complex and must be verified by an actuary for accuracy, the available ages are limited.

Referring now to FIG. 23, responsive to user selection of an administrative rights button 2702 on an actuarial office home page, an administrative rights plan setup screen 2700 is generated. The administrators in the system and associated with the actuarial office are retrieved, and displayed organized by groups according to the rights of the administrators. The groups are all rights group 2710, calculations group 2720, a data-download queries group (not shown), a data-view and save group (not shown) and a data view only group (not shown). In all rights group 2710, as an example, the system retrieves administrators previously entered and associated with the actuarial office and having all rights, and displays those administrators at 2705. The system provides options in each group to permit the user to add administrators at 2706 and to delete administrators. Administrator groups may be defined, at 2708. An administrator group has one or more administrators associated therewith, all of whom typically have the same rights.

Selection of database management module 1304 of FIG. 13 causes the system to launch database management module which provides an initial database management screen 2800, shown in FIG. 24. Modules are available for viewing and editing individual records 2802, for viewing and editing records pertaining to individual participants in plans. Reports module 2804 includes tools to facilitate user searches of the database and construction of reports from the results of the user searches. File management module 2806 permits the user to view and approve files containing data generated by the system, such as data update files and payroll files for transmission to payroll companies for use in deducting appropriate amounts from employee paychecks. Valuation related reports module 2808 permits the user to view reports related to preparing an actuarial valuation of a plan.

Referring to FIG. 25, an individual information screen 2900 generated by view/edit individual records module 2802 is shown. The system has provided the screen responsive to a user selection of the individual participant, such as by search in individual participant field 2902. Participant information includes typical name and address information, as well as birth date and gender information essential for actuarial analysis of a cash balance pension plan. Participant menu 2904 permits user selection of options to display and modify spouse, beneficiary, and alternate payee information. Plan information menu 2910 permits the user to select an option to display and modify various categories of information related to the particular participants plan data. The data involved may include plan dates and identification codes, employment status of the individual, inactive information, compensation of the individual, compensation for specific purposes, such as I.R.C. 415, the participants hours worked, formula override to alter default formulas for the particular employee; miscellaneous inputs to the database; the status of valuation of the plan; files related to the participant, and related documents. An other menu permits the user to calculate benefits for the participant or manage the system.

Referring to FIG. 26, the formula override functionality will be explained. Responsive to user selection of formula override from a participant menu, the system presents a formula override screen 3000. The formula override screen includes prompts for the user to select plan contribution data by start date that differs from the general formulas for the plan. The user may select a formula for the plan contributions, including percent of compensation, a flat dollar amount, or a combination of the two, for one or more time periods.

Definition drop down menu 3020 permits the user to select a sum, minimum or maximum of the percent or flat dollar amount formulas, or to select one or the other for determination of the pension plan contributions of the participant. Advantageously, the formula override provision permits the plan to accommodate participants who wish to contribute higher or lower amounts or percentages of compensation than are provided by the general plan formulas. For example, a highly compensated employee or an employee closer to retirement may wish to contribute a higher percentage of compensation to the plan than the default values of the plan. Certain categories of employees, such as shareholders or partners, may have higher levels of contributions to the plan.

A system according to an embodiment may be configured to permit a participant in a plan to access data regarding that participants account, and to perform calculations relating to benefits that the participant may receive under one or more assumptions. For example, a participant may have access to a benefits calculation module that is configured to retrieve information specific to that participant from a database and to perform benefit calculations and provide estimates of benefits available to the participant from the plan. The benefits calculation module may include tools that prompt the user to select available scenarios, such as retirement date scenarios and future earnings scenarios. Referring to FIG. 27, participant home screen 3200 is generated by a system to participants who have provided suitable credentials, such as a user identification and password. A participant may select a retirement module 3210, which provides projections for retirement benefits under selected scenarios, or a plan related documents module 3220, which makes retirement plan documents, such as periodic reports required under applicable statutes and regulations, available for review and download.

Referring to FIG. 28, responsive to selection of retirement module 3210, the system has generated a retirement options screen 3300. The available options are displayed at menu 3310. The menu options include accrued retirement benefits, which are those benefits available if the plan participant retired immediately. Menu options are also available for the retirement ages that are available under the plan setup procedure. The available options for accrued retirement benefits are shown at accrued benefits amounts display 3305. The accrued cash balance amount in the participant s hypothetical account as of a date determined by the system is shown. The calculation of the hypothetical cash balance is performed by the system using historical credited contributions and interest in accordance with formulas selected in plan setup. The system is configured to calculate exemplary benefit amounts, based on using the lump sum to purchase various types of income guarantees, which in this example are four types of single premium immediate annuities, namely a life annuity, a 50% joint and survivor annuity, a 75% joint & survivor annuity, and a 100% joint & survivor annuity. The benefit payments are shown in monthly amounts here, although other time periods, such as annual amounts, may be provided in other embodiments. In an embodiment, the system has stored, such as in a database or in a spreadsheet format, data indicative of annuitization rates for the age and gender of the participant and a survivor, for the available types of annuities. Such data may be in the form of, for a range of combinations of ages and gender for each available annuity type, a monthly payment amount for unit amount of annuity purchase price. In an embodiment, a system may be configured to access annuitization rates from an insurance company system on a periodic basis and to update stored annuitization data. In an embodiment, a system may be configured, in real time responsive to a participant request for data, to access annuitization rates from an insurance company system and employ the accessed annuitization rates in the calculation of the displayed income amounts. It will be appreciated that in other embodiments, projected income amounts for annuities without a known guaranteed income amount, i.e., annuities other than single premium immediate annuities, may be displayed, such as fixed deferred annuities, including annuities with guaranteed minimum income amounts, such as deferred variable annuities with guaranteed minimum withdrawal benefits. The system may be configured to display text with additional detail regarding the benefits payable under the exemplary types of annuities. For example, the text may explain that, in the 50% joint and survivor annuity, the participant receives a certain monthly benefit for the participants lifetime, and, upon the death of the participant, the surviving spouse receives a monthly benefit of one-half the original monthly amount for the remainder of his or her lifetime.

Responsive to participant selection of one of the available retirement ages from menu 3310, the system will calculate a projected hypothetical balance of the participants account in the plan, under certain assumptions. In an embodiment, the assumptions may include no change in wages or hours from the present until the selected retirement age. Based on the hypothetical balance, system may calculate monthly benefit amounts under various annuity scenarios. The calculated balance and monthly benefit amounts may be displayed. Assumptions, such as no change in wages or hours, may also be displayed. In other embodiments, other options for guaranteed or estimated income may be made available.

Referring to FIG. 29, responsive to participant selection of the scenario selection in menu 3310, scenario option input screen 3600 is generated by the system. The user may select a date of birth for a spouse or beneficiary at field 3605. The date of birth is used by the system in determining the monthly income amounts for single premium immediate annuities with lifetime benefits payable to the participant and the spouse or beneficiary, for example. The participant may select a date of termination of employment at field 3610, and a payment date at field 3615. The payment date is the date that the plan pays to the participant the hypothetical account balance, or purchases the single premium immediate annuity or other product. At field 3620, the participant may select an annual percentage increase in wages. In other embodiments, the participant may be provided a table to input varying annual percentage increases in wages. At field 3625, a drop down menu may be provided for the user to select input of future assumed hours, or other options, such as future hours being the same as the most recent years hours, or an average of hours for two or more recent prior years. In other embodiments, the system may generate a display that prompts a user to select from one or more options of changes in hours, such as to select hours continuing at a current rate for a period of years, and then changing to 75% of the current rate for a period of time, such as one or more years, prior to the selected termination date.

Responsive to input of data in scenario option input screen 3600 of FIG. 29, the system determines future employee contributions to the hypothetical account, future crediting of interest to the hypothetical account balance, a hypothetical account balance as of the assumed payment date, and future income amounts available from use of the hypothetical account balance to purchase single premium immediate annuities with various survivorship options. The system then presents on scenario display 3700 of FIG. 30 the calculated amounts in block 3705, including the hypothetical account balance as of the selected payment date, and monthly income amounts from use of that hypothetical account balance to purchase single premium immediate annuities, showing options for the life of the participant only, and various options for the lives of both the participant and a spouse/beneficiary having the birth date input by the participant. The calculation of the income amounts may employ current annuitization rates, or alternative rates, such as annuitization rates adjusted from current rates to compensate for current interest rates being higher or lower than average historical rates, and adjustments to estimate the effect of likely improved mortality prior to the assumed payment date. Block 3710 displays the assumptions input by the participant, including spouse/beneficiary date of birth, termination date and payment date. Future hours assumptions are also displayed and may be viewed by the participant by scrolling down, for example. The participant may be presented with an option to change one or more assumptions and re-run the calculations.

Referring again to FIG. 27, upon user selection of the plan related documents module 3220, the system returns a menu of available documents or categories of documents. The menu of available documents may include documents common to all participants in a given plan, such as a plan summary. The documents may include documents particular to the participant, such as W-4 and provisional W-4P (2009) forms. Links to other sources of information, such as the Social Security Administration website link, may also be provided. In an embodiment, links to electronic resources, such as websites, of third parties with whom the participant has accounts, which resources are configured to accept the same credentials, may be provided. By way of example, a link may be provided to a financial services provider that maintains defined contribution plans, such as 401(k) plans, so that the participant can access account information through a single login.

Referring to FIG. 31, an example of an implementation of a system employing spreadsheets, which may be deployed by a spreadsheet server, is shown. In FIG. 31, a spreadsheet tab 3900 is shown populated with data received from a web questionnaire tool such as that illustrated in FIGS. 17-22. Workbook 3900 includes fields populated with selections including age based flat dollar schedule, a negative answer to a percent of compensation schedule, a look back month, an interest credit assumption, and a Treasury look back month. Cells are available to receive user-selected data, including a flat dollar fixed amount, a percentage of compensation fixed amount, a formula combination, ages and percentages for an age-based percentage of compensation table, service years and percentages for a service-based percentage of compensation table, by way of example. Referring to FIG. 32, workbook 4000 implements a calculation of hypothetical account balance for a participant using both default and override formulas. A reference 4010 is provided to a flat dollar age table shown in FIG. 31.

Referring to FIG. 33, a sample of a workbook 4100 is shown illustrating a selection of formulas necessary to perform the calculation of the hypothetical account balance illustrated in FIG. 32.

Referring to FIG. 34, a sample of HTML code 4205 is shown. Code 4205 is generated by a spreadsheet and is used to generate web pages displaying results of calculations made, for example, by formulas shown in workbook 4100.

Referring to FIG. 35, a sample of participant-specific data 4300 embodied in a spreadsheet is shown. Each item is associated with a user identification 4305, which corresponds to individual participants in the plan.

Referring to FIG. 36, spreadsheet calculations employing participant-specific data 4300 are shown.

Referring to FIG. 37, another exemplary embodiment of a system 4500 of the present invention is shown. System 4500 includes a plan server 4510 which includes one or more engines or modules which may be utilized to perform one or more steps or functions of the present invention. In an embodiment, the present invention is implemented as one or more modules of a computer software program in combination with one or more components of hardware. Such software programs will be used generally where a client or customer has sent a request for data or information to a server and comprises part of the processing done on the server side of the network. Typically, the program will be used in an Internet environment, where the server is a Web server and the request is formatted using HTTP (or HTTPS). Alternatively, the server may be in a corporate intranet, and extranet, or any other type of network. Use of the term Internet herein, when discussing processing associated with the user's request, includes these other network environments, unless otherwise stated. Additionally, a graphical user interface or financial processing module may be implemented as an intelligent hardware component incorporating circuitry comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. One or more functions of web client or other module may be implemented as application software in the form of a set of processor-executable instructions stored in a memory of a client device, such as smart phone 4594, and capable of being accessed and executed by a processor of the client device.

Referring still to FIG. 37, server 4510 includes a data capture or input/output module 4530, a communications module 4540, a dynamic display generation or graphical user interface module 4550, a data module 4560, a data validation module 4562 and a practice management module 4564. Practice management module 4564 includes rules and pre-formatted template documents permitting management of an actuarial practice, including calendaring relevant statutory and regulatory deadlines, providing notifications of same to actuaries via populating local and web-based calendar programs, e-mail reminders, and reminders when actuaries are authenticated and in communication with server 4510. Practice management module may further prepopulate documents required for submission to regulators and correspondence required to be delivered to employers and participants with relevant data, such as names and addresses of companies, plans and participants, plan names, dates, identification numbers, plan census data, plan asset data, and other data. Practice management module may further make available one or more software tools for use by actuaries in testing plans against regulatory requirements, such as requirements for funding and notifications to participants.

Data module 4560 is in further communication with a number of databases such as actuarial office database 4580, employer database 4582, participant database 4584, plan database 4586, and a financial information database 4588 containing additional relevant financial information, such as annuitization rates, interest rates, and other data for facilitating plan setup and administration. Databases may include both internal and/or external/third party databases. By way of example, external databases may include insurance company databases for annuitization rate data and financial services entities databases for interest rate data. Server 4510 may be configured for bulk upload of data for plan administration, such as data relating to individual participants, such as name, address, birth date, service years, from databases and spreadsheets on client devices 4590, 4594 to a database associated with the server, such as participant database 4584. One or more modules may be configured to perform data validation steps prior to storing bulk uploaded data. Server 4510 may further be configured to permit bulk download of data, such as participant data, to a client device.

Spreadsheet server 4512 is in communication with system server 4510. Spreadsheet server 4512 dynamically and selectively loads spreadsheets 4514 to implement calculations for set up and administration of cash balance pension plans, as well as calculations of scenarios in response to participant requests. Spreadsheet server 4512 may create a new instance of stored spreadsheets to implement each newly created cash balance pension plan, and may store those instances in one or more physical and logical data locations. Spreadsheet server 4512 may interface with graphical user interface generation module 4550 to generate html code, by way of example, for transmission to client devices 4590, 4594, for display of data including results of scenarios and other calculations.

In operation, plan server 4510 is in communication with client devices, such as computer 4590 or smartphone 4594 via a network 4592 which facilitates interaction with plan server 4510 through one or more graphical user interfaces as shown and described herein. As used herein, devices, such as client devices 4590, 4594 may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Referring still to FIG. 37, utilizing client devices 4590, 4594, an outside actuary may setup and administer one or more new pension plans such as a cash balance plan as shown and described herein. A plan participant may also use client devices 4590, 4594 to access server 4510 and to obtain data concerning the participants account and plan related documents, and to employ spreadsheet server 4512 to execute scenarios based on selections of retirement age, future contribution, spouse birth date, and other data. In the exemplary embodiment, smartphone 4594 has a user calculation result display 4595 showing a projected account balance and monthly income amounts under various single premium immediate annuity options. In the present invention, one or more of the above modules, such as graphical user interface module 4550, data module 4560 and data validation module 4570 may also be implemented in combinations of software and hardware for execution by various types of computer processors coupled to such hardware.

Changes in law, regulations, accounting standards and the like may render changes to pension plans necessary. In an embodiment, an administrator may access server 4510, spreadsheets on spreadsheet server 4512, code for implementing modules, and the like, to input data indicative of a change in law applicable to all of the cash balance pension plans. The input data may implement alterations to each of the cash balance pension plans to comply with the new requirements under law, regulation, accounting standards or other applicable requirements.

As used herein, a module of executable code may, for instance, comprise one or more physical or logical blocks of computer instructions which may, for instance, be organized as an object, procedure, process or function. Nevertheless, the executables of an identified module need not be physically located together, but may comprise separate instructions stored in different locations which, when joined logically together, comprise the module and achieve the stated purpose for the module such as implementing the business rules logic prescribed by the present system. In the present invention a module of executable code may be a compilation of many instructions, and may even be distributed over several different code partitions or segments, among different programs, and across several devices. Similarly, data, including by way of example customer, company, employee, pension plan and insurance coverage information may be identified and illustrated herein within modules, and may be embodied in any suitable form and organized within any suitable type of data structure. Such data may be collected as a single data set, or may be distributed over different locations including over different storage devices, and may exist, at least partially, merely as electronic signals on a system and/or network as shown and described herein.

Referring now to FIG. 38, another embodiment of the present invention is shown whereby a computer server or client computer 4600 running a client application such as a Web browser or a thick client application renders a graphical user interface, such as a series of input screens for viewing and input from a customer or consumer. Server or client computer 4600 may include a processor 4610, e.g. CPU, memory 4620, I/O interface 4630 and a storage mechanism 4640 coupled together via a system bus 4650 over which the various elements may interchange data and information. Computer 4600 implements steps 4660-4668 in accordance with embodiments of the present invention.

Referring still to FIG. 38, in one embodiment, a number of definable and pre-determined or preselected variables or parameters are implemented in a plan setup configuration, 4660. Table 1 provides some representative key parameters and formats that are built into an exemplary Cash Balance plan template:

### Database Entries:

TABLE 1

| Field | Required Format |
|---|---|
| Compensation Date(s) | 12/31/yyyy |
| Hours Date(s) | 12/31/yyyy |
| Override Start Date | 01/01/yyyy |

Below in Table 2 are some representative Pre-defined Plan Provisions or Variables which may be fixed in a template in an embodiment of the present system:

TABLE 2

| | |
|---|---|
| Actuarial Equivalence | Applicable mortality table prescribed by |
| Mortality | the Secretary of the Treasury, as provided in |
| | IRC Section 417(e). |
| Actuarial Equivalence | Applicable interest rates prescribed by the |
| Interest | Sectary of the Treasury, as provided in IRC |
| | Section 417(e), for the look-back month |
| | defined in the default plan provisions of the |
| | calendar year containing the date of |
| | distribution. |
| Normal Retirement Age | The later of a defined age (62, 63, 64 or 65) |
| | and the 5th anniversary of the date of |
| | participation, as stored in the database. |
| Normal Retirement Date | First of the month on or after Normal |
| | Retirement Age. |
| Vesting Service/Accrual | Calendar year in which an employee has |
| Service | completed at least 1,000 hours. |
| Vesting Percent | 100% vested upon the first to occur of the |
| | following: |
| | Normal Retirement Date |
| | Date of completion of three or more |
| | years of Vesting Service |
| Optional Forms of | Life Annuity |
| Payment: | 50% Joint and Survivor Annuity |
| | 75% Joint and Survivor Annuity |
| | 100% Joint and Survivor Annuity |
| | Lump Sum |

In an embodiment, the following defined practices may be employed:
For age based formulas, age is measured in complete years as of January 2001.
For service based formulas, service is equal to Accrual Service as of January 2001.
Interest in partial years is determined using compound interest on completed months.
For optional forms, ages are measured in nearest whole years.
Optional factors are rounded to 5 decimal places and then annualized

The use of the foregoing assumptions in a template significantly simplifies the creation and administration of the sets of formulas, which may be embodied in spreadsheets, that implement the templates. In other templates, other standardized assumptions may be employed.

Referring still to FIG. 38, login identification information from an outside actuary accessing the system from a client device over a network is then validated, 4662. The system receives a request from the validated user from the client device over the network to create a new plan 4664. The system prompts for and collects company related information, 4666, such as by causing a display to be generated on the client device, and receiving input entered by the validated user into the display. The system also prompts for and collects administrator information, 4668, such as by causing a display to be generated on the client device, and receiving input entered by the validated user into the display. The system also prompts for and collects plan definition information, 4670, such as by causing a display to be generated on the client device, providing selections available among the pre-selected variables implemented in the plan set up configuration, receiving input entered by the validated user into the display, which input includes available selections. The system also prompts for and collects plan input information, 4672, including participant information. The system then performs calculations 4674 to implement the plan. All of the received information and results of calculations are stored in a database. The system makes available 4676, for remote access from a client device over the network, plan information, to administrators depending on rights associated with each administrator. Administrators also have rights to modify data, depending on the rights granted. The system also makes available for participants by remote access from a client device over the network information concerning the participants account, as well as general plan information.

Referring to FIG. 39, an embodiment of a system according to the invention having a management console will be described. In FIG. 39, hardware server 4700 is an exemplary server in communication with network 4730, which may be the Internet. Hardware server 4700 may be implemented as one or more actual or virtual servers, by way of example. Hardware server 4700 is an exemplary computer for performing set up and administration of multiple cash balance pension plans in an application service provider mode. Hardware server 4700 has management console 4710 for management of an interactive pension plan set up system. In the embodiment of FIG. 39, management console 4710 maintains a question-based plan set up tool 4712 that is configured to present fillable forms and questions to actuaries accessing the system, such as from user devices 4732, 4733, for set up of pension plans. Set up tool 4712 maintains questions and logic among the questions, and furnishes data provided from user device 4732 to pension plan database 4750 and to spreadsheets 4740 that have formulas for implementing calculations required for set up and administration of pension plans. Management console 4710 also includes system administrator tools 4714. System administrator tools 4714 permit an authorized system administrator, accessing server 4700, such as from administrator workstation 4716, to modify questions and logic of set up tool 4712. The logic includes the order of questions or screens, and the questions and screens provided responsive to a particular user response. The calculation logic for set up and administration of plans is implemented entirely in spreadsheets 4740. Management console 4710 provides system administrators the capacity to change, remove and add questions to be presented to actuaries for plan set up, as well as to change the logic and grouping of questions. Management console 4710 is also configured to permit system administrators to create and modify templates, and to associate particular templates with particular users or groups of users. By way of example, a template with a more limited number of options, such as permitting contributions to be determined only as a percentage of compensation and not as a flat amount, may be available for actuaries associated with a particular actuarial office.

Advantageously, the configuration of FIG. 39 avoids the need for an expert system and the creation of custom code to create new plans or new variations in plans. Actuaries can access the system and create new plans, using calculations already available in existing spreadsheets. System administrators can add capabilities by adding calculations to spreadsheets, and by implementing corresponding questions in the management console.

Referring to FIG. 40, there is shown an exemplary screen shot of a screen 4800 generated by system administrator tool 4714, such as may be viewed by a system administrator on administrator workstation 4716. From screen 4800, a system administrator may view a list of questions at 4805, select one of the questions, and modify features such as text 4810, data type, element type, reference 4815 to cell of spreadsheet 4740 of FIG. 39. A system administrator may further select values 4820 for a drop down menu.

Referring to FIG. 41, there is shown an exemplary screen shot of a screen 4900 generated by system administrator tool 4714, such as may be viewed by a system administrator on administrator workstation 4716, for viewing and modifying grouping of questions. Groupings of questions may be added at 4910. At 4920, an example of a question is shown, and at 4930, an example of an explanatory paragraph is shown.

Referring to FIG. 42, there is shown an exemplary screen shot 5000 listing questions available in a template. The user can view details of questions so as to alter the question wording, the type of data, and the pointers to spreadsheets, as well as to delete and add questions. Templates can be modified for varying levels of complexity.

Referring to FIG. 43, there is shown an exemplary screen shot 5100 showing changes that can be made to a template at a question grouping level, including changes in the order of question groupings, adding question groupings, deleting question groupings, and changing details, such as associated questions. At 5110, companies having pension plans associated with the template and associated actuarial offices are listed.

The present invention may be implemented in a server/workstation hardware environment. Such a representative environment may comprise a representative client device, computer or intelligent workstation, such as a personal computer or terminal including related peripheral devices. The representative device or workstation includes a microprocessor and a bus employed to connect and enable communication between the microprocessor and the components of the device or workstation in accordance with known techniques. The workstation typically includes a user interface adapter, which connects the microprocessor via the bus to one or more interface devices, such as a keyboard, mouse, and/or other interface devices, which can be any user interface device, such as a touch screen, voice recognition module, digitized entry pad, etc. Interface devices may be used to provide input and make selections related to plan setup and administration. The bus also connects a display device, such as an LCD screen or monitor, to the microprocessor via a display adapter. The bus also connects the microprocessor to memory and long-term storage which can include a hard drive diskette drive, tape drive, etc. for storing plan related information.

The present invention may be implemented in an application service provider environment. The user device may implement a web browser or other thin client software, used for display and input of data, while a server provides application service provider services, including execution of all processes and storing of data. Processes may be executed by a calculation engine, which may be implemented, by way of example, by a spreadsheet server executing calculations contained in a spreadsheet or an interrelated set of spreadsheets. Changes to calculations and logic may be implemented by updating a spreadsheet by a system administrator.

The workstation communicates via a communications channel with other computers or networks of computers such as a plan server of the present invention. The workstation may be associated with such other computers in a local area network (LAN) or a wide area network (WAN), or the workstation can be a client in a client/server arrangement with another computer, etc. All of these configurations, as well as the appropriate communications hardware and software, are contemplated for use with the plan setup module of the present invention.

In the present invention a network or data processing network may be employed which may include a plurality of individual networks, such as a wireless network and a landline based network, each of which may include a plurality of servers, individual workstations or personal computers. Additionally, as those skilled in the art will appreciate, one or more LANs may be included where a LAN may comprise a plurality of intelligent workstations coupled to a host processor for enable and facilitating plan setup and administration. The networks may also include mainframe computers or servers, such as a gateway computer or application server. A gateway computer serves as a point of entry into each network. The gateway may be preferably coupled to another network by means of one or more communications links. The gateway may also be directly coupled to one or more workstations using a communications link. The gateway computer may also be coupled to a storage device for storing information related to the plan setup and administration. Further, the gateway may be directly or indirectly coupled to one or more workstations. Those skilled in the art will appreciate that the gateway computer may be located geographically remote from the network, and similarly, the workstations may be located geographically remote from the networks and/or network servers. The client devices or workstations may connect to the wireless network using a networking protocol such as the Transmission Control Protocol/Internet Protocol (“TCP/IP”) over a number of alternative connection media, such as cellular phone, radio frequency networks, satellite networks, etc. The wireless network may connect to the gateway using a network connection a such as TCP (Transmission Control Protocol) or UDP (User Datagram Protocol) over IP, X.25, Frame Relay, ISDN (Integrated Services Digital Network), PSTN (Public Switched Telephone Network), etc.

In this manner, a system may be provided that allows incoming plan setup and administration requests to processed with an increased level of automation, accuracy and efficiency. Note that the automation may lower transaction costs and these savings might be shared by all parties (e.g., the employer, employee, the independent actuary and the insurer/financial services provider). As the automation provides for templates which provide varying amounts of customization, with little or no need for creation of customized code for a new implementation, plans may be developed with a wide variety of provisions, thereby serving the needs of a variety of employers with increased efficiency.

While particular embodiments of the invention have been illustrated and described in accordance with pension planning, various modifications and combinations can be made without departing from the spirit and scope of the invention, and all such modifications, combinations, and equivalents are intended to be covered and claimed.

What is claimed is:

1. A real-time cash balance defined benefit pension plan setup and administration system comprising:
a hardware server in communication with a network, the hardware server comprising a processor and a memory device;
a plan set up module configured for access via the network from user devices for set up of cash balance defined benefit pension plans, the plan set up module having a plurality of pre-defined plan provisions, the plan set up module configured to receive data from the user devices for establishing cash balance pension plans in accordance with selection of one or more of the pre-defined plan provisions;
a calculation engine for performing calculations for implementation of the cash balance pension plans based on the received data, the pre-defined plan provisions, and stored formulas, data employed by the calculation engine comprising: an employer associated with each of the cash balance pension plans; a plurality of individual participants associated with each of the cash balance pension plan; an account associated with each of the participants; a formula for crediting contributions to the accounts; a formula for crediting interest to the accounts; and formulas for determining cash balances of the accounts, the cash balances representing general obligations of the employer;
a report module configured to furnish reports of the cash balance pension plans in response to requests received from user devices;
wherein each of said modules is configured for execution on the server and access by a plurality of user devices via the network.

2. The system of claim 1, further comprising a benefits calculation module configured to determine, responsive to an inquiry received from a user device via the network, dollar amounts of benefits available to one of the participants.

3. The system of claim 1, further comprising a database management module for permitting an administrator access from a user device via the network to a database containing data pertinent to one or more of the cash balance pension plans.

4. The system of claim 1, further comprising a trust payment module for permitting an administrator to make payments from a trust account to a participant or beneficiary.

5. The system of claim 1, further comprising a rights management module configured to establish one or more administrators of each of the cash balance pension plans, the administrators having access to the cash balance pension plans via the network.

6. The system of claim 1, wherein the plan set up module is configured to cause prompts to be displayed on a user device for selections of predefined plan set up provisions.

7. The system of claim 6, wherein the prompts comprise prompts for selections of periodic contribution amounts based on one of a flat amount, an amount variable based on number of years of service of a participant, and an amount variable based on an age of the participant.

8. The system of claim 1, wherein the calculation engine comprises a spreadsheet server operative to create a new instance of a stored spreadsheet responsive to a user request to create a new cash balance pension plan.

9. The system of claim 8, wherein the spreadsheet server is configured to store a spreadsheet configured in accordance with each of the cash balance pension plans.

10. The system of claim 1, wherein the system is configured to receive bulk uploads of data relative to the cash balance pension plans from user devices via the network.

11. The system of claim 1, further comprising a practice management module for tracking requirements for documents for submission to regulators for plan compliance, for notifying a user of timing and items for submission to regulators, and for storing documents submitted to regulators.

12. The system of claim 1, wherein the system is configured to, responsive to receiving identification information from one of the plan participants, access and present data relating to an account of the plan participant in one of the cash balance plans.

13. The system of claim 1, wherein the data employed by the calculation engine further comprises: a formula for determining based on participant service to the employer within a period entitlement to a contribution and a formula for determining based on duration of service vesting of balances in the accounts in participants.

14. The system of claim 1, wherein the network comprises the Internet.

15. The system of claim 1, wherein the hardware server is configured as an application service provider.

16. The system of claim 1, wherein, responsive to input of data at the hardware server indicative of a change in law applicable to the cash balance pension plans, alterations to each of the cash balance pension plans are implemented.

17. A computer-implemented method for cash balance defined benefit pension plan setup and administration, comprising:
receiving via a network, at a hardware server connected to the network, requests to set up cash balance defined benefit pension plans;
responsive to each of the requests, prompting by the server for selection of a plurality of plan provisions from a plurality of available plan provisions, including permitted retirement ages, formulas for contributions by participants to accounts, formulas for crediting of interest to accounts, formulas for determining based on participant service to the employer within a period entitlement to a contribution; and formulas for determining based on duration of service vesting of account balances in participants;
receiving by the server selections of plan provisions;
performing by the server calculations for implementation of the cash balance pension plan based on the received selections, stored pre-defined plan provisions, and stored formulas, data employed by the calculation engine comprising: an employer associated with the cash balance pension plan; a plurality of participants associated with the cash balance pension plan; an account associated with each of the participants; and formulas for determining cash balances of the accounts, the cash balances representing general obligations of the company; and
furnishing by the server via the network reports of the cash balance pension plan.

18. The method of claim 17, further comprising, responsive to a request from one of the plan participants, calculating in real time a projected cash balance for the plan participant at a future time selected by the plan participant.

19. The method of claim 17, further comprising calculating a periodic income available to the participant assuming the projected cash balance is used to purchase a single premium immediate annuity for the life of the participant.

20. The method of claim 17, further comprising receiving from the participant future service hours, and employing the received future service hours in the calculating of the projected cash balance.

21. The method of claim 17, wherein the step of calculating comprises employing a spreadsheet server.

22. The method of claim 13, further comprising prompting a user to select one of a plurality of cash balance pension plan templates, each template having associated therewith a plurality of formulas stored in one or more distinct spreadsheets.

23. The method of claim 17, further comprising receiving a law change and implementing the received law change with respect to each of the cash balance pension plans.

24. An on-demand real-time pension plan setup and administration system,
a hardware server having a processor and a memory and in communication with a network; and
a data storage unit in communication with the hardware server,
the hardware server being configured to:
prompt, via the network, an authorized actuary employing a client device to select one of each of a plurality of pre-defined selections for set up of a cash balance defined benefit pension plan for an employer;
receive, via the network, a plurality of selections from the authorized actuary;
based on the received selections, store data associated with the pension plan in the data storage unit;
using the stored data, implement set up of the pension plan, wherein the data comprises: an employer associated with the cash balance pension plan; a plurality of participants associated with the cash balance pension plan; an account associated with each of the participants; a formula for crediting contributions to the accounts; a formula for crediting interest to the accounts; a formula for determining based on participant service to the employer within a period entitlement to a contribution; a formula for determining based on duration of service vesting of account balances in participants; and formulas for determining cash balances of the accounts, the cash balances representing general obligations of the employer; and
responsive to authorized user inquiries over the network, furnish data concerning the pension plan to authorized users over the network.

25. The system of claim 24, wherein the pre-defined selections comprise:
formulas for crediting contributions to the accounts based on compensation; formulas for crediting contributions to the accounts based on a flat amount per defined period;
formulas for crediting contributions to the accounts based on a combination of service period and one of compensation or a flat amount per defined period; and formulas for crediting contributions to the accounts based on a combination of employee age and one of compensation or a flat amount per defined period.

26. The system of claim 25, wherein the pre-defined selections comprise:
rules for determining conditions for application of either formulas for crediting contributions to the accounts based on a flat amount per defined period or formulas for crediting contributions to the accounts based on compensation.

27. The system of claim 24, wherein the hardware server is configured to permit formulas for contributions to the accounts to be distinct for one or more individual participants.

28. The system of claim 24, wherein the pre-defined selections comprise: flat percentage formulas for crediting interest to the accounts; percentage formulas having a date-dependent variation for crediting interest to the accounts; and an index for determining a rate of interest for crediting to the accounts.

29. The system of claim 24, wherein the hardware server is further configured to provide, responsive to a request from one of the participants from a client device over the network, in real time, a projected cash balance for the participant at a future time selected by the participant.

30. The system of claim 29, wherein the hardware server is further configured to calculate and provide to the participant in real time a periodic income available to the participant assuming the projected cash balance is used to purchase a single premium immediate annuity for the life of the participant.

31. A computer-implemented method for set up of a cash balance pension plan from a client device over a network, comprising:
accessing from the client device a hardware server via the network,
receiving by the client device from the hardware server via the network prompts for selections of provisions of a cash balance pension plan, and displaying the prompts;
receiving by the client device data from a user responsive to the prompts and providing the data to the hardware server via the network, the data including: an employer associated with the cash balance pension plan, a plurality of individual participants associated with the cash balance pension plan, formulas for crediting contributions and interest to accounts associated with each of the individual participants and for determining cash balances of the accounts, the cash balances representing general obligations of the employer; and
receiving by the client device from the hardware server cash balance pension plan data indicative of a cash balance pension plan consistent with the data provided to the hardware server and pre-defined plan provisions and displaying the cash balance pension plan data.

32. The computer-implemented method of claim 31, further comprising communicating from the client device a request for amounts of benefits available under the plan to one of the individual participants, and receiving and displaying by the client device amounts of benefits responsive to the request.

33. The computer-implemented method of claim 31, wherein the data responsive to the prompts further comprises a formula for determining based on participant service to the employer within a period entitlement of the participant to a contribution to the account associated with the participant.

34. The computer-implemented method of claim 31, further comprising communicating from the client device to the hardware server actuarial office data, the actuarial office being associated with a plurality of plans.

35. A computer-readable medium having a plurality of instructions thereon which, when executed by a processor, cause the processor to:
receive from client devices via a network requests to set up cash balance defined benefit pension plans;
responsive to each of the requests, cause a client device to prompt a user for data relating to a new cash balance defined benefit pension plan, including:
plan name, employer associated with the plan, individual participants associated with the plan, formulas for contributions by participants to accounts associated with each of the participants and for crediting of interest to accounts, wherein balances of the accounts represent obligations of the employer;
receiving plan set up data input in response to the prompts;
performing by the server calculations for implementation of the cash balance pension plans based on the received plan set up data, stored pre-defined plan provisions, and stored formulas; and formulas for determining cash balances of the accounts, the cash balances representing general obligations of the company; and
storing data for a plurality of the cash balance plans.

36. The computer-readable medium of claim 35, wherein the instructions, when executed by a processor, further cause the processor to, responsive to an inquiry received from a user device via the network, calculate dollar amounts of benefits available to one of the participants and output the calculated dollar amounts to the user device.

37. The computer-readable medium of claim 35, wherein the instructions, when executed by a processor, further cause the processor to calculate a projected cash balance for one of the participants at a user-generated future date and to calculate a periodic income available to the participant assuming the calculated cash balance is used to purchase a single premium immediate annuity for the life of the participant.
